(19) United States
(12) Patent Application Publication
(10) Pub. No.: US 2016/0196002 A1
(43) Pub. Date: Jul. 7, 2016

(54) DISPLAY DEVICE

(71) Applicant: SHARP KABUSHIKI KAISHA, Osaka-shi, Osaka (JP)

(72) Inventors: Yoichi KUGE, Osaka (JP); Noriyuki HOSHIAI, Osaka (JP)

(73) Assignee: Sharp Kabushiki Kaisha, Osaka-shi, Osaka (JP)

(21) Appl. No.: 14/916,111

(22) PCT Filed: Aug. 13, 2014
(86) PCT No.: PCT/JP2014/071374

§ 371 Date: Mar. 2, 2016

(30) Foreign Application Priority Data
Sep. 4, 2013 (JP) 2013-183291

(51) Int. Cl. G06F 3/041; G06F 3/0354

(52) U.S. Cl. CPC G06F 3/0418; G06F 3/0412; G06F 3/03545

(57) ABSTRACT

A display device includes: a display unit having a rectangular display area; a touch panel on the display unit; and a processor configured to perform the following: causing a character image to be displayed in a determination area located in a corner of the display area such that the character image contacts two sides of the determination area that border an exterior of the display area; determining whether a hand gripping the touch pen is a left hand or a right hand in accordance with input locations of the touch pen on the character image and a display location of the character image; detecting a shift amount in accordance with the input locations of the touch pen on the character image and the display location of the character image; and correcting an input location of the touch pen in the display area in accordance with the detected shift amount.

### TECHNICAL FIELD

The present invention relates to a display device, and in particular, relates to a technology that corrects an input location by a touch pen in a display device equipped with a touch panel.

### BACKGROUND ART

Mobile phones, tablet devices, and the like that include a touch panel display have recently become popular. There may be instances in a display device equipped with a touch panel in which, depending on the usage environment, there is a decrease in the accuracy in detecting an input location, and it may be necessary to perform calibration in order to correct the input location. As disclosed in Japanese Patent Application Laid Open Publication No. 2011-164742, for example, there is a method for performing calibration in which the display device displays an adjustment screen showing a cross mark or the like in order to adjust coordinates on the touch panel, and then adjusts the coordinates on the touch panel in accordance with the results of a contact operation for the cross mark by a user.

Japanese Patent Laid Open Publication No. 2003-271314 discloses a technology that corrects input location on a touch panel in accordance with dominant hand information. In Japanese Patent Laid Open Publication No. 2003-271314, the display device takes into account that a position that differs from a target position on the display panel may be input on the touch panel as a result of factors such as the roundness of the touch pen, the respective thicknesses of the touch panel and the display panel, and the like. The device then displays a plurality of marks in prescribed locations and corrects the input location. When a touch pen or the like is used to perform a contact operation with respect to the marks, it is difficult to perform the contact operation as the location approaches the edges of the display area near the dominant hand. Thus, in accordance with dominant hand information input by the user, the plurality of marks are displayed in a higher density moving toward the edges of the display area near the dominant hand. In Japanese Patent Laid Open Publication No. 2003-271314, by increasing the display density of the marks at the edges of the display area near the dominant hand, there is an increase in the amount of correction near the edges of the display area near the dominant hand, and the input location is corrected more accurately.

### SUMMARY OF THE INVENTION

As disclosed in Japanese Patent Laid Open Publication No. 2011-164742 and Japanese Patent Laid Open Publication No. 2003-271314, when symbols such as a cross mark are displayed in order to adjust a coordinate range on the touch panel, there are cases in which the input operation is done such that what is displayed is not accurately input. In such a case, it is not possible to appropriately adjust the coordinate range on the touch panel. This is due to parallax occurring in the touch panel display as a result of the distance between the display panel and the touch panel, and the like, resulting in a difference between an input target location and the input location input on the touch panel. Another reason for this is that since the direction of the line of sight toward the touch panel will vary according to which hand is gripping the touch pen, shifts in input location due to parallax will vary according to which hand is gripping the touch pen. Thus, when the input location is corrected by a fixed amount regardless of which hand is gripping the touch pen, it is not possible to correct the input location to the location that the user desires.

The present invention provides a technology in which is possible to correct shifts in input location due to parallax based on which hand is gripping the touch pen.

A display device according to a first aspect of the present invention includes: a display unit having a rectangular display area; a touch panel; a display control unit that displays a character image in a determination area located in a corner of the display area such that the character image contacts two sides of the determination area that border an exterior of the display area; a determination unit that determines whether a hand gripping a touch pen is a left hand or a right hand in accordance with input locations of the touch pen on the character image and a display location of the character image; a detection unit that detects a shift amount with respect to the respective input locations in accordance with the input locations of the touch pen on the character image and the display location of the character image; and a correction unit that corrects an input location of the touch pen in the display area in accordance with a determination result from the determination unit and a detection result from the detection unit.

A second aspect of the present invention is configured such that, in the first aspect of the present invention: a plurality of the determination areas are respectively located in two opposing corners of the display area, the character image is displayed in the plurality of the determination areas, the display device further includes a setting unit that sets a coordinate range of the touch panel that corresponds to the display area in accordance with the input locations of the touch pen on the character images displayed in the respective determination areas, and the correction unit further corrects the input location of the touch pen in accordance with the coordinate range set by the setting unit.

A third aspect of the present invention is configured such that, in either the first or second aspects of the present invention: an upright direction of a character shown in the character image is substantially parallel to an extension direction of one of the two sides of the determination area, the character image has a line segment that is substantially parallel to the one side, and the detection unit detects the shift amount in the input locations in accordance with input locations of the touch pen on the line segment and a display location of the line segment.

A fourth aspect of the present invention is configured such that, in any one of the first to third aspects of the present invention: the character image includes a curved line that curves toward one of the two sides of the determination area, the one side being substantially parallel to an upright direction of a character shown in the character image, the display control unit displays the character image such that a section of the curved line contacts the one side of the determination area, and the determination unit determines whether the hand gripping the touch pen is the left hand or the right hand by determining whether or not a trajectory of input locations of the touch pen on the section of the curved line is located within the determination area.

A fifth aspect of the present invention is configured such that, in any one of the first to third aspects of the present invention: the character image includes a curved line that curves toward the two respective sides of the determination area, and the display control unit displays the character image such that portions of the curved line contact the two sides of the determination area.

A sixth aspect of the present invention is configured such that, in the first to fifth aspects of the present invention, if an input operation other than by the touch pen is performed on the touch panel and if the input operation is an input operation by a hand, the determination unit further determines which hand is gripping the touch pen in accordance with a positional relationship between an input location of the input operation by the hand and the input locations of the touch pen.

A seventh aspect of the present invention is configured such that, in any one of the first to fifth aspects of the present invention, if an input operation other than by the touch pen is performed on the touch panel near at least two opposing sides of four sides forming the display area, the determination unit further determines which hand is gripping the touch pen in accordance with a contact area of the input operation.

An eighth aspect of the present invention is configured such that, in any one of the first to seventh aspects of the present invention: the display control unit sets a lock function when the display device is turned ON and/or when a non-input state in which no input operation is performed on the touch panel lasts for a prescribed period of time, the lock function not allowing any input operation other than a character sequence that matches a character sequence of a prescribed password to be accepted until the character sequence is input, the display control unit deactivating the lock function when the character sequence that matches the character sequence is input, the character image is a portion of the character sequence of the prescribed password, and when an input operation is performed by the touch pen after the lock function has been deactivated, the correction unit corrects an input location of the input operation.

A ninth aspect of the present invention is configured such that, in any one of the first to eighth aspects of the present invention, the display control unit further displays an instruction image for directing operation of an application installed on the display device in a location in the display area based on the determination result from the determination unit.

According to the configurations of the present invention, it is possible to appropriately adjust a coordinate range on the touch panel and correct an input location based on which hand is gripping the touch pen.

### BRIEF DESCRIPTION OF THE DRAWINGS

FIG. 1 is a block diagram showing a schematic configuration of a display device according to an embodiment.

FIG. 2 is a block diagram showing functional blocks of the control unit shown in FIG. 1.

FIG. 3 is a schematic diagram showing an example of a character image in a display area of the display panel shown in FIG. 1.

FIG. 4A shows an example of a location of the character image in a coordinate plane of the display area shown in FIG. 3.

FIG. 4B is a schematic diagram in which a character image shown in FIG. 4A has been enlarged.

FIG. 4C is a schematic diagram in which a character image shown in FIG. 4A has been enlarged.

FIG. 5 is a schematic diagram that shows the default values for the coordinate plane of the touch panel shown in FIG. 1.

FIG. 6A illustrates a shift in the input location due to parallax when a touch pen is being gripped by the left hand.

FIG. 6B illustrates a shift in the input location due to parallax when a touch pen is being gripped by the right hand.

FIG. 7 is a chart showing a flow of operation in the display device according to the embodiment.

FIG. 8A is a schematic diagram showing examples of a character image in Modification Example (1).

FIG. 8B is a schematic diagram in which a character image shown in FIG. 8A has been enlarged.

FIG. 8C is a schematic diagram in which a character image shown in FIG. 8A has been enlarged.

FIG. 9A is a schematic diagram showing examples of a character image in Modification Example (1).

FIG. 9B is a schematic diagram in which a character image shown in FIG. 9A has been enlarged.

FIG. 10 is a schematic diagram showing examples of a character image in Modification Example (2).

FIG. 11A is a schematic diagram in which a character image shown in FIG. 10 has been enlarged.

FIG. 11B is a schematic diagram in which a character image shown in FIG. 10 has been enlarged.

FIG. 12 is a schematic diagram showing an example of a character image in Modification Example (3).

FIG. 13A is a schematic diagram in which a character image shown in FIG. 12 has been enlarged.

FIG. 13B is a schematic diagram in which a character image shown in FIG. 12 has been enlarged.

FIG. 14 is a schematic diagram showing an example of a lock screen of Modification Example (5).

FIG. 15 is a schematic diagram that illustrates determination of the hand gripping the touch pen according to Modification Example (7).

FIG. 16 is a schematic diagram that illustrates determination of the hand gripping the touch pen according to Modification Example (8).

### DETAILED DESCRIPTION OF EMBODIMENTS

A display device according to one embodiment of the present invention includes: a display unit that has a rectangular display area; a touch panel; a display control unit that displays a character image in a determination area located in a corner of the display area such that the character image contacts two sides of the determination area that border the exterior of the display area; a determination unit that determines which hand is gripping a touch pen in accordance with an input location of the character image by the touch pen and a display location of the character image; a detection unit that detects an amount of shift in the input location in accordance with the input location of the character image by the touch pen and the display location of the character image; and a correction unit that corrects the input location by the touch pen in the display area in accordance with the determination results of the determination unit and the detection results of the detection unit (Configuration 1).

According to Configuration 1, the display control unit displays the character image in the determination area located in the corner of the rectangular display area such that the character image contacts two sides of the determination area that border the exterior of the display area. The determination unit determines which hand is gripping the touch pen in accordance with the input location of the character image by the touch pen and the display location of the character image. The detection unit detects the amount of shift in the input location. When the touch pen performs an input operation, the correction unit corrects the input location in accordance with the determination results of the hand gripping the touch pen and the amount of shift in the input location. The character image is displayed in the determination area so as to contact two sides of the determination area that border the exterior of the display area. Compared to a symbol such as a cross mark, it is easier to input a character image exactly as displayed. Thus, when the character image is appropriately input, it is possible to correct the input location to the correct location in accordance with the detection results of the amount of shift in the input location and the determination results regarding the hand gripping the touch pen that are based on the input location of the character image. As a result, compared to cases in which the input location is corrected by a fixed amount regardless of which hand is gripping the touch pen, it is possible to improve the accuracy in correcting the input location.

Configuration 2 may be configured such that in Configuration 1: the character image is displayed in respective determination areas located in two opposing corners of the display area; the display device further includes a setting unit that sets a coordinate range on the touch panel that corresponds to the display area in accordance with the input location by the touch pen of the character image displayed in the determination areas; and the correction unit further corrects the input location by the touch pen in accordance with the coordinate range set by the setting unit.

According to Configuration 2, the character image is displayed in the respective determination areas located in two opposing corners of the display area. The setting unit sets the coordinate range on the touch panel in accordance with the input location by the touch pen of the character image displayed in the respective determination areas. The correction unit corrects the input location by the touch pen in accordance with the set coordinate range of the touch panel. When the character images displayed in the respective determination areas are appropriately traced, it is possible to identify opposite corner locations of the display area from the input locations, appropriately set a coordinate range of the touch panel that corresponds to the display area, and improve accuracy in correcting the input location.

Configuration 3 may be configured such that, in Configuration 1 or Configuration 2: an upright direction of the character shown in the character image is substantially parallel to an extension direction of one of the two sides of the determination area; the character image includes a line segment that is substantially parallel to the one side; and the detection unit detects shift in the input location in accordance with the input location of the line segment and the display location of the line segment.

According to Configuration 3, the character in the character image is substantially parallel to an extension direction of one of the two sides of the determination area that border the exterior of the display area. The character image includes a line segment that is substantially parallel to the above-mentioned side. In other words, the character image includes a line segment that is substantially parallel to the upright direction of the character. Normally, a user performs input after fixing the display device such that the characters are displayed upright in front of the user. When a line segment that is substantially parallel to the upright direction of the character is appropriately traced, it is possible to detect the amount of shift in a direction orthogonal to the line segment, or in other words, in the left/right direction of the user, and it is possible to correct the shift in the input location that results from the parallax experienced by the user.

Configuration 4 of the present invention may be configured such that, in any one of Configurations 1 to 3: the character image includes a curved line that curves toward one of the two sides of the determination area, the side of the determination area being substantially parallel to the upright direction of the character displayed in the character image; the display control unit displays the character image such that a section of the curved line contacts the one side of the determination area; and the determination unit determines which hand is gripping the touch pen by determining whether or not the trajectory of the input locations of the section of the curved line by the touch pen is located within the determination area.

According to Configuration 4, the character image includes a curved line that curves toward one of the two sides of the determination area, with the one side of the determination area being substantially parallel to the upright direction of the character in the character image. A portion of the curved line contacts the above-mentioned one side of the determination area. The device determines which hand is gripping the touch pen by determining whether or not the trajectory of the input locations of the section of the curved line input by the touch pen is located within the determination area. Compared to a straight line, it is easier to appropriately input a curved line without stopping until the line reaches the border with the exterior of the display area. Since the input location shifts to the left or right due to parallax based on which hand is holding the pen, it is possible to easily determine which direction the input location has shifted toward as a result of whether or not the trajectory of the input locations are within the determination area. As a result, it is possible to easily determine which hand is gripping the touch pen.

Configuration 5 may be configured such that, in any one Configurations 1 to 3: the character image includes a curved line that curves toward both respective sides of the determination area; and the display control unit displays the character image such that a portion of the curved line contacts the two sides of the determination area.

According to Configuration 5, the character image includes a curved line that curves toward both respective sides of the determination area that border the exterior of the display area, and is displayed such that a portion of the curved line touches the respective sides. Compared to a straight line, it is easier to appropriately input a curved line without stopping until the line reaches a border with the exterior of the display area. When the character image is appropriately traced, it is possible to identify, from the input locations, locations on the touch panel that border the exterior of the display area, and to more appropriately adjust the coordinate range on the touch panel.

Configuration 6 may be configured such that, in any one of Configurations 1 to 5, when an input operation is performed on the touch panel by an object that is not the touch pen, the determination unit further determines, when the input operation is an input operation by a hand, which hand is gripping the touch pen in accordance with the positional relationship of the input location of the input operation by the hand and the input location by the touch pen.

According to Configuration 6, the device determines which hand is gripping the touch pen in accordance with the positional relationship of the input location by the hand and the input location by the touch pen. When an input operation is performed by the touch pen, there may be cases in which the input operation is performed in a state in which the hand gripping the touch pen is being supported by the touch panel. There is a fixed positional relationship between the location at which the hand gripping the touch pen contacts the touch panel and the input location by the touch pen, or in other words, the location of the tip of the touch pen. Thus, it is possible to more reliably determine which hand is gripping the touch pen as a result of the positional relationship between the input location where the hand is contacting the touch panel and the input location by the touch pen.

Configuration 7 may be configured such that, in any one of Configurations 1 to 5, when an input operation is performed on the touch panel near at least two opposing sides among four sides forming the display area by an object that is not the touch pen, the determination unit further determines which hand is gripping the touch pen in accordance with a contact area of the input operation.

According to Configuration 7, when an input operation is performed by an object that is not the touch panel near two opposing sides that are part of the display area, the device further determines which hand is gripping the touch pen in accordance with a contact area on the touch panel by the input operation and the input location by the touch pen. When the user holds the display device in a hand opposite from the hand holding the touch pen and performs an input operation on the touch panel via the touch pen, the fingers of the hand holding the touch panel may contact the touch panel at a location near the two opposing sides of the display area. In such a case, the area of the fingers contacting the touch panel near the two sides will vary according to which hand is gripping the touch pen. Thus, by determining which hand is gripping the touch pen via the contact area of the input operation that is near the opposing two sides of the display area and that is not performed by the touch pen, it is possible to increase determination accuracy compared to Configuration 1.

Configuration 8 may be configured such that, in any one of Configurations 1 to 7: the display control unit sets a lock function when the device is turned ON and/or when a non-input state, in which no input operation is performed on the touch panel, continues so as to exceed a fixed period of time, the lock function making it so that no input operation other than a character sequence that matches a character sequence of a prescribed password is accepted until the character sequence is input; the display control unit deactivates the lock function when a character sequence that matches the above-mentioned character sequence is input; the character image is a portion of the character sequence of the prescribed password; and when an input operation is performed by the touch pen after the lock function has been deactivated, the correction unit corrects the input location of the input operation.

According to Configuration 8, the device sets a lock function by displaying a character image that is a portion of the character sequence of the prescribed password when either the device is turned ON and/or a non-input state on the touch panel continues so as to exceed a fixed period of time. When the prescribed password is input via an input operation, the lock function is deactivated. After the lock function is deactivated, the input location of an input operation is corrected if the input operation was performed by the touch pen. Thus, it is not necessary to separately provide a screen for correcting the input location and a screen for setting the lock function, and the user may perform input operations on just one screen.

Configuration 9 may be configured such that, in any one of Configurations 1 to 8, the display control unit further displays an instruction image for directing the operation of an application installed on the device in a location in the display area based on the determination results of the determination unit.

According to Configuration 9, an instruction image for directing the operation of an application installed on the display device is displayed in a location of the display area based on the determinations results of the hand gripping the touch pen; thus, it is possible to improve the operability of the application.

An embodiments of the present invention will be described in detail below with reference to the drawings. Portions in the drawings that are the same or similar are assigned the same reference characters and descriptions thereof will not be repeated.

(Configuration)

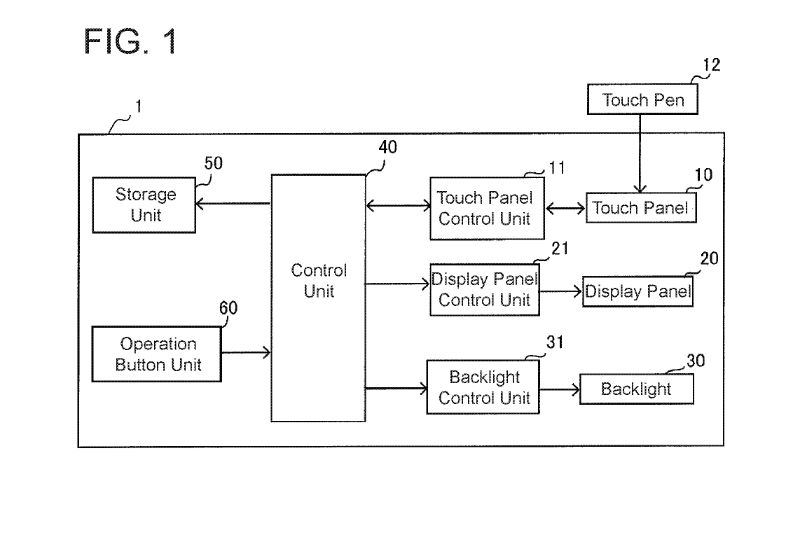

FIG. 1 is a block diagram showing a schematic configuration of a display device according to the present embodiment. The display device 1 is used in a smartphone, a tablet device, or the like, for example. The display device 1 includes: a touch panel 10, a touch panel control unit 11, a display panel 20, a display panel control unit 21, a backlight 30, a backlight control unit 31, a control unit 40, a storage unit 50, and an operation button unit 60. Each of these units will be described below.

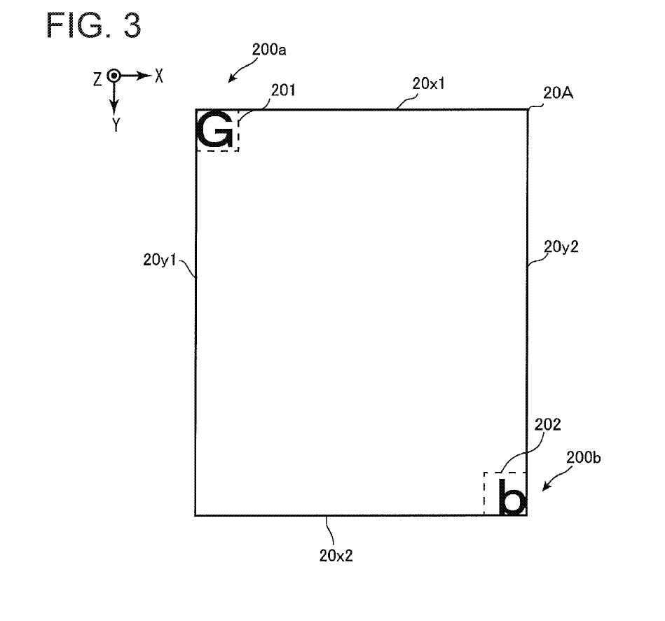

The touch panel 10 is a capacitive type touch panel, for example. The touch panel 10 includes a group of drive electrodes (not shown) and a group of sense electrodes (not shown) arranged in a matrix, and has a sensing area formed by the group of drive electrodes and the group of sense electrodes. The touch panel 10 is provided upon the display panel 20 such that a display area 20A (see FIG. 3) of the display panel 20, which will be described later, and the sensing area overlap. The touch panel 10 sequentially scans the group of drive electrodes via the control of the touch panel control unit 11, which will be described later, and outputs signals that indicate capacitance from the group of sense electrodes.

The touch panel control unit 11 outputs sequential scan signals to the drive electrodes of the touch panel 10, and detects contact on the touch panel 10 when the signal value output from the sense electrodes meets or exceeds a threshold value. When the touch panel control unit 11 detects contact on the touch panel 10, the touch panel control unit 11 detects whether or not the contact was made by a touch pen 12 in accordance with the signal value from the sense electrodes. The operation of determining whether or not the contact was made by the touch pen 12 is performed by determining whether or not the signal value from the sense electrodes falls within a threshold range (hereafter referred to as a “touch pen determination threshold range”) that represents a change in capacitance when the touch pen 12 contacts the touch panel 10. When the signal value from the sense electrodes falls within the touch pen determination threshold range, the touch panel control unit 11 determines that the contact was made by the touch pen 12. When the signal value does not fall within the touch pen determination threshold range, the touch panel control unit 11 determines that the contact was not made by the touch pen 12.

Moreover, the touch panel control unit 11 detects as the input location coordinates corresponding to a location at which the drive electrode and the sense electrode for which the signal value from the sense electrode was obtained intersect. In addition, the touch panel control unit 11 outputs to the control unit 40 the detection results indicating whether or not the contact was made by the touch pen 12 and coordinates representing the detected input location. The coordinates of the input location detected by the touch panel control unit 11 are coordinates within a coordinate range (default values) that is initially set to correspond to the display area 20A.

The display panel 20 is a liquid crystal panel in which a liquid crystal layer (not shown) is sandwiched between an active matrix substrate, which transmits light, and an opposite substrate (both not shown). On the active matrix substrate, a plurality of gate lines (not shown) and a plurality of source lines (not shown) that intersect the gate lines are formed. The substrate includes the display area 20A (see FIG. 3) that is made of pixels defined by the gate lines and the source lines. A pixel electrode (not shown) connected to a gate line and a source line is formed in each of the pixels of the active matrix substrate, and a common electrode (not shown) is formed on the opposite substrate.

The display panel control unit 21 has: a gate driver (not shown) that scans the gate lines (not shown) of the display panel 20, and a source driver (not shown) that provides data signals to the source lines (not shown) of the display panel 20. The display panel control unit 21 outputs a prescribed voltage signal to the common electrode and outputs control signals, including timing signals such as clock signals, to the gate driver and the source driver. As a result, the gate lines are sequentially scanned by the gate driver, the data signals are provided to the source lines by the source driver, and an image based on the data signals is displayed in the respective pixels.

The backlight 30 is provided to the rear of the display panel 20. The backlight 30 has a plurality of LEDs (light-emitting diodes), and lights the plurality of LEDs in accordance with the luminance indicated by the backlight control unit 31, which will be described later. The backlight control unit 31 outputs a luminance signal to the backlight 30 that is based on a luminance indicated by the control unit 40.

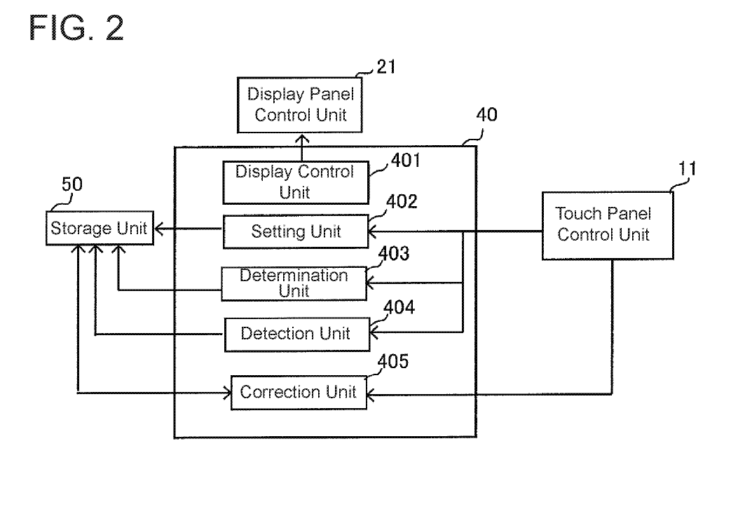

The control unit 40 has a CPU (central processing unit; not shown) and memory, which includes ROM (read only memory) and RAM (random access memory). FIG. 2 is a functional block diagram of the control unit 40. The control unit 40, via the CPU carrying out control programs stored in the ROM, realizes the respective functions of a display control unit 401, a setting unit 402, a determination unit 403, a detection unit 404, and a correction unit 405 shown in FIG. 2, and thereby calibrates the touch panel 10. Each of these units will be described below.

The display control unit 401 causes the display panel control unit 21 to display a character image for calibrating the touch panel 10 when the display device 1 is turned ON. FIG. 3 is a schematic diagram showing an example of the display area 20A of the display panel 20. The sides 20x1, 20x2, 20y1, and 20y2 forming the display area 20A in FIG. 3 border the exterior of the display area. In FIG. 3, the location from which the user views the display device 1 is in the positive direction of the Z axis, the positive direction of the X axis is the right-hand direction of the user, and the negative direction of the X axis is the left-hand direction of the user.

Character images 200a, 200b are respectively displayed in a display area 201 (a determination area) and a display area 202 (a determination area). The display area 201 and the display area 202 are located in opposing corners that serve as a reference for indicating the range of the display area 20A. The display area 201 is enclosed by the sides 20x1, 20y1, as well as two other sides that serve as borders with other display areas in the display area 20A. The display area 202 is enclosed by the sides 20x2, 20y2, as well as two other sides that serve as borders with other display areas in the display area 20A.

In the present embodiment, the character image 200a is a capital letter “G,” while the character image 200b is a lowercase letter “b.” In the example shown in FIG. 3, the character images 200a, 200b are displayed such that the upright directions of the respective letters are substantially parallel to the respective extension directions of the sides 20y1, 20y2 of the display area 20A. The character images 200a, 200b are displayed such that portions of the respective letters contact the border of the respective display areas 201, 202 and the exterior of the display area. In other words, the character image 200a is displayed such that portions of the “G” contact the sides 20x1, 20y1. The character image 200b is displayed such that portions of the “b” contact the sides 20x2, 20y2.

Next, the setting unit 402 will be explained. When an input operation has been made by the touch pen 12 for the character images 200a, 200b displayed in the display area 20A, the setting unit 402 sets reference coordinates representing a coordinate range within the touch panel 10 in accordance with the input location of the character images 200a, 200b within the default values of the sensing area.

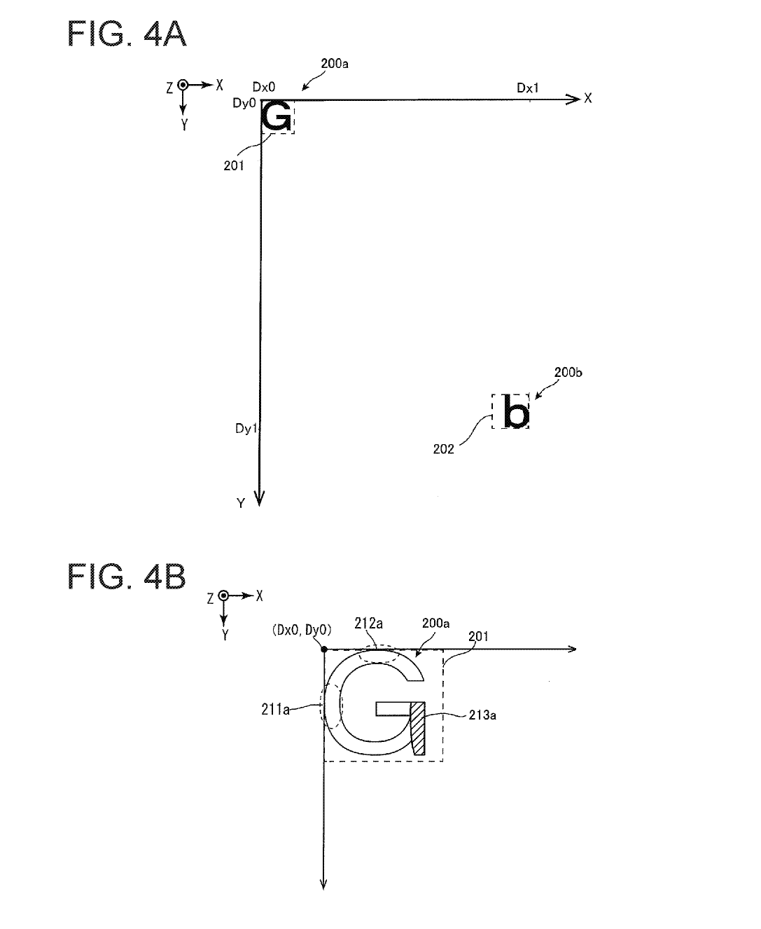

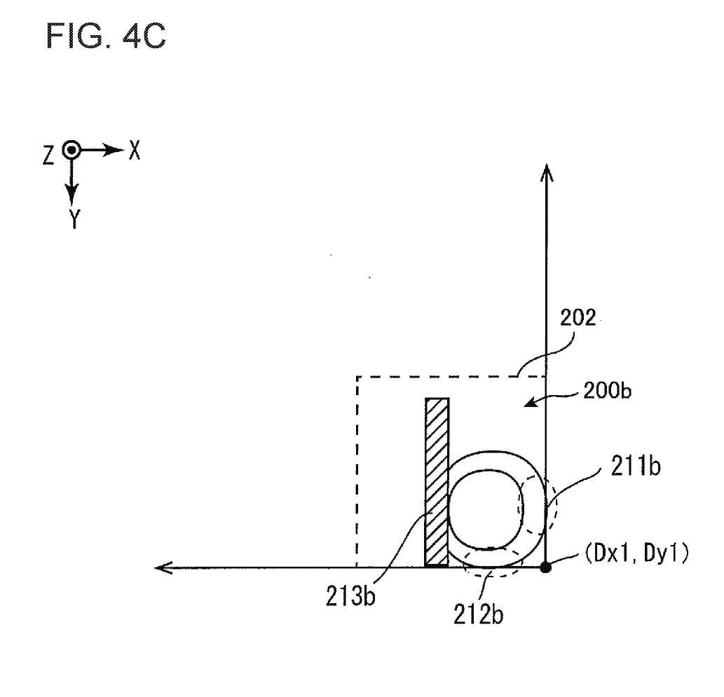

FIG. 4A is a schematic diagram that shows the display locations of the character images 200a, 200b in the coordinate plane of the display area 20A. In this example, the coordinate range of the display area 20A is from (Dx0, Dy0) to (Dx1, Dy1). The side 20y1 in FIG. 3 corresponds to the Y axis of the coordinate plane shown in FIG. 4A, and the side 20x1 in FIG. 3 corresponds to the X axis of the coordinate plane shown in FIG. 4A. Furthermore, the side 20y2 in FIG. 3 corresponds to X=Dx1 in the coordinate plane shown in FIG. 4A, and the side 20x2 in FIG. 3 corresponds to Y=Dy1 in the coordinate plane shown in FIG. 4A.

In the display area 201 shown in FIG. 4A, the letter “G,” which represents the character image 200a, is displayed such that portions thereof contact the X axis and the Y axis. FIG. 4B is a schematic diagram in which the character image 200a shown in FIG. 4A has been enlarged. As shown in FIG. 4B, portions 211a, 212a of the letter “G” in the character image 200a are in contact with the Y axis and the X axis, respectively.

In other words, the character displayed in the character image 200a includes a line that is not parallel to the sides 20x1, 20y1, which form the border of the display area 201 and the exterior of the display area. Portions of this non-parallel line contact the sides 20x1 (X axis), 20y1 (Y axis) respectively. In other words, in FIG. 4B, the portions 211a, 212a of the character image 200a are portions of a line that is not parallel to the Y axis and the X axis.

Similarly, in the coordinate plane shown in FIG. 4A, the character image 200b is displayed such that portions of the letter “b” contact X=Dx1 and Y=Dy1. FIG. 4C is a schematic diagram in which the character image 200b shown in FIG. 4A has been enlarged. As shown in FIG. 4C, portions 211b, 212b of the letter “b” in the character image 200b contact X=Dx1 and Y=Dy1, respectively.

In other words, the letter shown in the character image 200b includes a line that is not parallel to the sides 20x2, 20y2, which form the border of the display area 202 and the exterior of the display area. Portions of this non-parallel line contact the sides 20x2 (Y=Dy1), 20y2 (X=Dx1), respectively. In other words, in FIG. 4C, the portions 211b, 212b of the character image 200b are portions of the line that is not parallel to Y=Dy1 and X=Dx1.

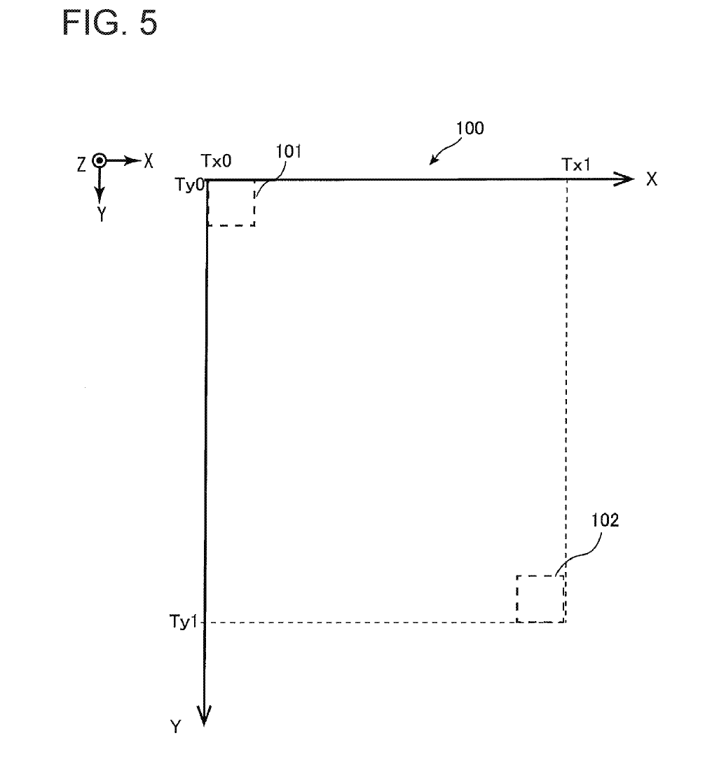

The default values for the sensing area of the touch panel 10 are set so as to correspond to the coordinate plane of the display area 20A. FIG. 5 is a schematic diagram representing the coordinate plane with the default values for the sensing area. In this example, the default values of the sensing area are set to (Tx0, Ty0) and (Tx1, Ty1). The default values (Tx0, Ty0) and (Tx1, Ty1) correspond to the coordinates (Dx0, Dy0) and (Dx1, Dy1) in the display area 20A. In FIG. 5, a dotted line frame 101 encloses an area corresponding to the display area 201, and a dotted line frame 102 encloses an area corresponding to the display area 202.

An input operation made by the touch pen 12 for the character images 200a, 200b is an operation in which the character images 200a, 200b are traced using the touch pen 12. Since portions of the character image 200a are in contact with the X axis and the Y axis, input locations near the X axis and the Y axis of the sensing area are detected when the character image 200a is traced appropriately. Therefore, among the coordinates for the input locations by the touch pen 12 for the character image 200a, the minimum X coordinate (Tx0′, for example) and the minimum Y coordinate (Ty0′, for example) correspond to the minimum X coordinate (Dx0) and the minimum Y coordinate (Dy0) in the display area 20A.

In addition, since portions of the character image 200b are in contact with Y=Dy1 and X=Dx1, input locations near X=Dx1 and Y=Dy1 in the sensing area are detected when the character image 200b is traced appropriately. Therefore, among the coordinates for the input locations by the touch pen for the character image 200b, the maximum X coordinate (Tx1′, for example) and the maximum Y coordinate (Ty1′, for example) correspond to the maximum X coordinate (Dx1) and the maximum Y coordinate (Dy1) in the display area 20A.

The setting unit 402 resets the default values by setting (Tx0′, Ty0′) and (Tx1′, Ty1′), which are based on the input locations for the character images 200a, 200b, as reference coordinates indicating the coordinate range of the sensing area. The setting unit 402 stores the reference coordinates (Tx0′, Ty0′), (Tx1′, Ty1′) for the touch panel 10 in the storage unit 50.

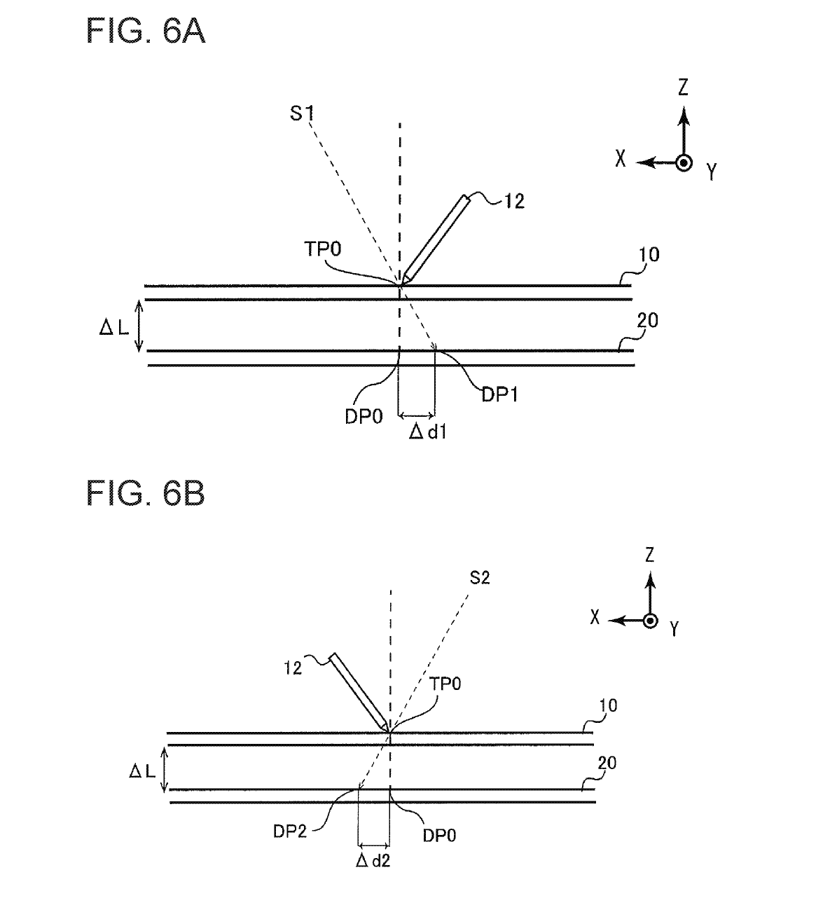

Next, the relationship between the hand (dominant hand) gripping the touch pen 12 and shifts in the input location as a result of parallax will be explained. The direction to which the input location shifts as a result of parallax depends on which hand is gripping the touch pen 12. FIGS. 6A and 6B respectively show shifts in the input location as a result of parallax when the hand gripping the touch pen 12 is the left hand and the right hand. FIG. 6A shows a case in which the hand gripping the touch pen 12 is the left hand, and FIG. 6B shows a case in which the hand gripping the touch pen 12 is the right hand. The touch panel 10 and the display panel 20 are provided with a fixed gap ΔL therebetween. In FIGS. 6A and 6B, the positive direction of the Z-axis is the direction from the display device 1 toward the location of the viewer, the negative direction of the X axis is the direction toward the left of the user, and the positive direction of the X axis is the direction toward the right of the user.

When the user grips the touch pen 12 with the left hand and performs input on the touch panel 10, the user sees the location where he will perform input from the right side of the left hand. Thus, as shown in FIG. 6A, a parallax M1 occurs between a location TP0 on the touch panel 10 that is along the line of sight S1 of the user and a location DP1 (input target location) on the display panel 20 as a result of the distance ΔL between the touch panel 10 and the display panel 20. As a result, the user performs input using the touch pen 12 at the location TP0 that is on the touch panel 10 and that is along the line of sight S1 of the user. Thus, a location DP0, which is located Δd1 to the left of the location DP1, becomes the input location instead of the location DP1 on the display panel 20.

Meanwhile, when the user grips the touch pen 12 with the right hand and performs input on the touch panel 10, the user sees the location where he will perform input from the left side of the right hand. Thus, as shown in FIG. 6B, a parallax Δd2 occurs between a location TP0 that is on the touch panel 10 and that is along a line of sight S2 of the user and a location DP2 (input target location) on the display panel 20 as a result of the distance ΔL between the touch panel 10 and the display panel 20. As a result, the user performs input using the touch pen 12 at the location TP0 that is on the touch panel 10 and that is along the line of sight S2 of the user. Thus, a location DP0, which is located Δd2 to the right of the location DP2, becomes the input location instead of the location DP2 on the display panel 20.

In this manner, the input location shifts to the right (positive direction of the X axis) of the display location (input target location) on the display panel 20 when the hand gripping the touch pen 12 is the right hand, and shifts to the left (negative direction of the X axis) of the display location (target input location) of the display panel 20 when the left hand is gripping the touch pen 12. The determination unit 403 determines which hand is gripping the touch pen 12 in accordance with the display location of the character image 200a and the input location of the character image 200a by the touch pen 12 within the default value coordinate plane of the sensing area.

The portion 211a of the curved line in the character image 200a shown in FIG. 4B is displayed so as to contact the Y axis. The determination unit 403 determines, within the defaults values of the sensing area, whether or not a trajectory of a plurality of continuous input locations input in a display range (hereafter referred to as a determination target range) for the portion 211a of the character image 200a are located within the display area 201.

When the user traces the portion 211a of the character image 200a while gripping the touch pen 12 with his right hand, the input location will shift to the right (positive direction of the X axis) of the display location (input target location) as a result of parallax; thus, the input location for the portion 211a of the character image 200a will be located within the display area 201. Thus, the determination unit 403 determines that the hand gripping the touch pen 12 is the right hand when a line connecting a plurality of continuous input locations in the determination target range is located within the display area 201.

Meanwhile, the determination unit 403 determines that the hand gripping the touch pen 12 is the left hand when a line connecting a plurality of continuous input locations in the determination target range is not located within the display area 201. When the user traces the portion 211a of the character image 200a while gripping the touch pen 12 with the left hand, the input location will shift to the left (negative direction of the X axis) of the display location (input target location) as a result of parallax; thus, it is likely that the portion 211a of the character image 200a will overlap the border (Y axis) with the exterior of the display area. As a result, the line connecting the input locations for the portion 211a of the character image 200a will be cut off at the border (Y axis) with the exterior of the display area. The determination unit 403 stores in the storage unit 50 the determination results determined in accordance with the input location of the partial image 211a.

Next, the detection unit 404 will be explained. The detection unit 404 detects shifts along the X axis for the input location of the character image 200a, and detects the amount of shift (correction value) between the input location and the display location of the character image 200a. Specifically, in the present embodiment, the detection unit 404 detects the amount of shift between the display location of the partial image 213a indicated by diagonal lines in the character image 200a shown in FIG. 4B and the input location by the touch pen 12 for the partial image 213a. The partial image 213a is a line segment image that is substantially parallel to the Y axis. The detection unit 404 calculates differences between the plurality of X coordinates corresponding to the display location of the partial image 213a and a plurality of X coordinates from among the input locations for the partial image 213a within the default value coordinate plane of the sensing area, and then determines an average value for the various calculated differences. If the calculated average value falls within a prescribed threshold range, the detection unit 404 sets the average value as the amount of shift in the input location of the partial image 213a. In addition, when the calculated average value does not fall within the prescribed threshold range, the detection unit 404 sets a preset default value as the amount of shift in the input location of the partial image 213a. The detection unit 404 stores in the storage unit 50 the amount of shift (correction value) for the detected input location.

In the present embodiment, in accordance with the input location of the character image 200a, the device determines which hand is gripping the touch pen 12 and then detects an amount of shift in the input location. However, the determination of the hand gripping the touch pen 12 and the detection of the amount of shift in the input location may be performed in accordance with the input location of the character image 200b. When the character image 200b is used, the determination unit 403 determines, within the default values for the sensing area, whether or not the trajectory of the plurality of continuous input locations that were input within the determination target range and that correspond to the portion 211b of the character image 200b is located within the display area 202.

When the user grips the touch pen 12 in the right hand and then traces the character image 200b, it is likely that the input position will shift to the right due to parallax. On the other hand, when the user grips the touch pen 12 in his left hand and then traces the character image 200b, it is likely that the input position will shift to the left due to parallax. Thus, the determination unit 403 determines that the hand gripping the touch pen 12 is the right hand when the line connecting the input locations corresponding to the portion 211b of the character image 200b is not located within the display area 202, and determines that the hand gripping the touch pen 12 is the left hand when the line is located within the display area 202.

In addition, when a shift in the input location is detected using the character image 200b, the detection unit 404 detects the shift in accordance with the input location of the partial image 213b of the character image 200b shown in FIG. 4C and the display location of the partial image 213b. The partial image 213b is a line segment image that is substantially parallel to X=Dx1 and the Y axis. The detection unit 404 calculates differences between the plurality of X coordinates corresponding to the display location of the partial image 213b and a plurality of X coordinates from among the input locations for the partial image 213b in the default value coordinate plane of the sensing area, and then determines an average value for the various calculated differences. If the calculated average value falls within a prescribed threshold range, the detection unit 404 sets the average value as the amount of shift in the input location.

The description will be continued while referring back to FIG. 2. After the reference coordinates, information regarding the hand gripping the touch pen 12, and the amount of shift (correction value) in the input locations have been stored in the storage unit 50, the correction unit 405 corrects the input location input via the touch pen 12 in accordance with the reference coordinates, the information regarding the hand gripping the touch pen 12, and the amount of shift (correction value) in the input location.

The description will be continued while referring back to FIG. 1. The storage unit 50 is a non-volatile storage medium such as flash memory. In addition to storing various types of data such as application programs executed in the display device 1, application data used in the applications, and user data, the storage unit 50 stores other various kinds of data such as the reference coordinates set by the control unit 10, the information regarding the hand gripping the touch pen 12, and the amount of shift (correction value) in the input location.

The operation button unit 60 includes the operation buttons of the display device 1, such as the power button and menu buttons. The operation button unit 60 outputs an operation signal that represents the content of the user operation to the control unit 40.

### Operation Example

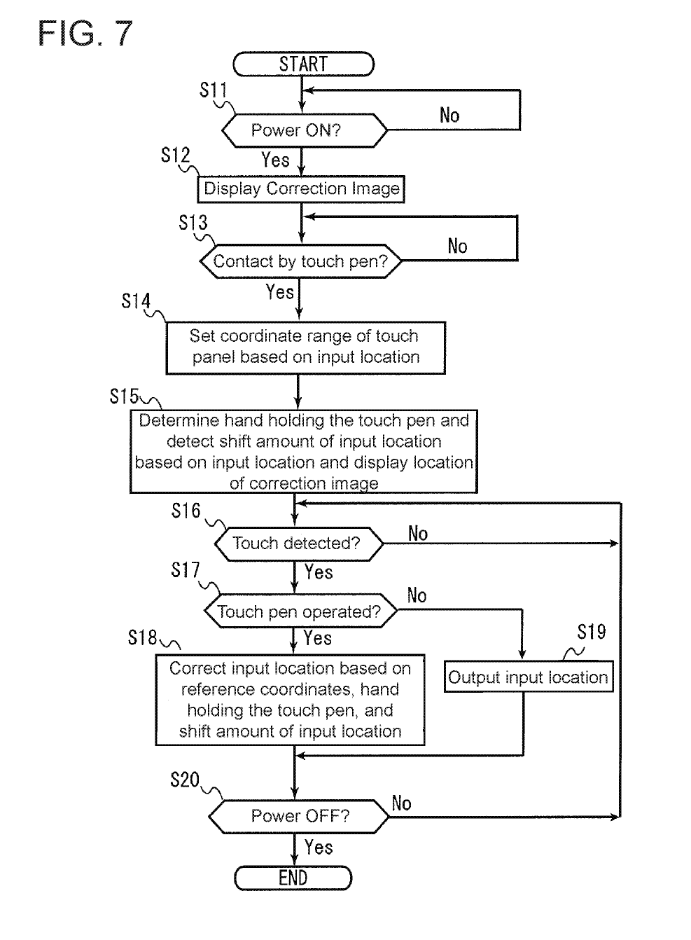

FIG. 7 is an operational flow chart that shows an operation example of the display device 1 of the present embodiment. When the control unit 40 receives an operation signal via the operation button unit 60 that the power button of the display device 1 has been turned ON (Step S11: Yes), the control unit 40, via the display panel control unit 21, displays the respective character images 200a, 200b shown in FIG. 3 in the display areas 201, 202 within the display area 20A of the display panel 20, and initiates calibration of the touch panel 10 (Step S12).

The user then performs an operation of tracing the character images 200a, 200b displayed in the display area 20A via the touch pen 12. The control unit 40, via the touch panel control unit 11, waits while displaying the character images 200a, 200b until the control unit 40 acquires the coordinates indicating the location contacted by the touch pen 12 (Step S13: No). After acquiring the coordinates indicating the position contacted by the touch pen 12 (Step S13: Yes), the control unit 40, via the touch panel control unit 11, resets the default values for the coordinate range of the touch panel 10 by setting reference coordinates indicating the coordinate range of the touch panel 10 in accordance with the acquired coordinates (Step S14).

Specifically, the control unit 40 identifies, from among the coordinates acquired from the touch panel control unit 11, coordinates included in a region 101 (see FIG. 5) that corresponds to a display area 201 within the default coordinate plane of the sensing area as the input location of the character image 200a. The control unit 40 then identifies a minimum X coordinate and a minimum Y coordinate from the coordinates for the input locations of the character image 200a. Then, the control unit 40 sets the identified X coordinate and Y coordinate as the minimum values (Tx0′, Ty0′) for the coordinate range of the touch panel 10.

Furthermore, the control unit 40, identifies, from among the coordinates acquired from the touch panel control unit 11, coordinates includes in a region 102 (see FIG. 5) that corresponds to a display area 202 within the default coordinate plane of the sensing area as the input location of the character image 200b. The control unit 40 then identifies a maximum X coordinate and a maximum Y coordinate from the coordinates for the input location of the character image 200b. The control unit 40 then sets the identified X coordinate and Y coordinate as the maximum values (Tx1′, Ty1′) for the coordinate range of the touch panel 10. The control unit 40 stores in the storage unit 50 the reference coordinates (Tx0′, Ty0′), (Tx1′, Ty1′) that indicate the set coordinate range.

Next, the control unit 40 detects the determination of the hand gripping the touch pen 12 and the amount of shift (correction value) of the input location in accordance with the input location of the character image 200a and the display location of the character image 200a.

Specifically, the control unit 40 determines whether or not a trajectory of a plurality of continuous input locations input by the user within the determination range, which corresponds to the partial image 211a of the character image 200a shown in FIG. 4B and which is in the default coordinate plane of the sensing area, are located within the display area 201. In other words, the control unit 40 identifies, from the coordinates acquired from the touch panel control unit 11, a plurality of input locations included in a determination target range in the sensing area that corresponds to the partial image 211a shown in FIG. 4B. The control unit 40 then determines that the hand gripping the touch pen 12 is the right hand when the trajectory of the identified input locations are within the display area 201. In addition, the control unit 40 determines that the hand gripping the touch pen 12 is the left hand when the trajectory of the identified input locations is not located within the display area 201. The control unit 40 stores information indicating the determination results in the storage unit 50.

Next, the control unit 40 detects the difference between the display location of the partial image 213a of the character image 200a shown in FIG. 4B and the input location of the partial image 213a. The control unit 40 then calculates differences between the plurality of X coordinates corresponding to the display location of the partial image 213a and the X coordinates for a plurality of input locations for the partial image 213a within the default values of the sensing area, and then determines an average value for the various calculated differences for the X coordinates. If the calculated average value falls within a prescribed threshold range, the control unit 40 stores the average value in the storage unit 50 as the amount of shift (correction value) in the input value. In addition, when the calculated average value does not fall within the prescribed threshold range, the control unit 40 stores a default value in the storage unit 50 as the amount of shift (correction value) for the input location of the partial image 212.

After calibration, the control unit 40 executes a prescribed application, and waits until coordinates indicating the input location are acquired from the touch panel control unit 11 (Step S16: No). When the control unit 40 acquires coordinates ((Tx2, Ty2), for example) indicating the input location from the touch panel control unit 11 (Step S16: Yes), if the coordinates are an input location contacted by the touch pen 12 (Step S17: Yes), the control unit 40 corrects the acquired coordinates (Tx2, Ty2) in accordance with the reference coordinates (Tx0′, Ty0′), (Tx1′, Ty1′) in the storage unit 50, the information indicating which hand is gripping the touch pen 12, and the amount of shift (correction value) in the input location (Step S18).

The coordinates acquired from the touch panel control unit 11 are coordinates within the default values ((Tx0, Ty0) to (Tx1, Ty1)) of the sensing area. The control unit 40 converts the acquired coordinates (Tx2, Ty2) into coordinates within the coordinate range ((Tx0′, Ty0′) to (Tx1′, Ty1′)) of the reference coordinates. Specifically, the coordinates (Tx2′, Ty2′) within the reference coordinates may be acquired by changing the default values, the reference coordinates, and the acquired coordinates into variables, and inserting the default values, the reference coordinates, and the acquired coordinates into a prescribed arithmetic formula for correcting the acquired coordinates, for example.

The amount of shift in the input location due to parallax is not taken into account in the converted coordinates (Tx2′, Ty2′). The control unit 40 corrects the coordinates (Tx2′, Ty2′) in accordance with the information indicating which hand is gripping the touch pen 12 and the correction value. In other words, when the hand gripping the touch pen 12 is the right hand, the control unit 40 corrects the X coordinate of the coordinates (Tx2′, Ty2′) to an X coordinate (Tx2′-Δdx) that has been shifted toward the negative direction of the X axis (left direction) by the correction amount (Δdx). Furthermore, when the hand gripping the touch pen 12 is the left hand, the control unit 40 corrects the X coordinate of the coordinates (Tx2′, Ty2′) to an X coordinate (Tx2′+Δdx) that has been shifted toward the positive direction of the X axis (right direction) by the correction amount (Δdx). The control unit 40 outputs coordinates representing the corrected input location to the application that is being executed.

Meanwhile, when the control unit 40 acquires the coordinates representing the contact location (input location) from the touch panel control unit 11 (Step S16: Yes), if the coordinates are not an input location resulting from contact by the touch pen 12 (Step S17: No), the control unit 40 outputs the acquired coordinates to the application being executed (Step S19).

The control unit 40, via the operation button unit 60, repeats the processing starting at Step S17 until receiving an operation signal indicating that the power has been turned OFF (Step S20: No). When the control unit 40 receives the operation signal indicating that the power has been turned OFF, the control unit 40 ends the above-mentioned processing (Step S20: Yes).

In the above-mentioned embodiment, a character image 200a representing the letter “G” was displayed in the display area 201 located in one of two opposing corners in the display area 20A, while a character image 200b representing the letter “b” was displayed in the other display area 200b. The letters in the character images 200a, 200b include lines that are not parallel to the two sides of the display areas 201, 202 that border the exterior of the display area. These character images 200a, 200b are displayed such that portions of these non-parallel lines contact the above-mentioned two sides. Since the character images 200a, 200b represent letters, the user can more intuitively trace what is displayed compared to cases in which a symbol such as a cross mark is displayed. Thus, it is possible to detect a location near the border of the display areas 201, 202 and the exterior of the display area from the input location of the character images 200a, 200b, and it is possible to set an appropriate coordinate range as the sensing area of the touch panel 10 that corresponds to the display area 20A.

In addition, in the above-mentioned embodiment, the display device determines whether or not a trajectory of the input locations for the portion 211a of the character image 200a displayed so as to contact the border with the exterior of the display area is located within the display area 201. The portion 211a of the character image 200a is a curved line. A curved line is easier to input without stopping compared to a straight line. Thus, it is possible to determine the direction to which the input location shifts as a result of parallax, or in other words, determine which hand is gripping the touch pen 12, from the trajectory of the input locations for the portion 211a of the character image 200a.

The partial image 213a of the character image 200a is a portion of a line segment that is substantially parallel to the upright direction of the character in the character image 200a. When the partial image is a portion of a line that is not parallel to the upright direction of the character, the partial image has a component in the upright direction of the character and a component in a direction orthogonal to the upright direction of the character; thus, when the device detects a shift in the input location, these various components must be taken into consideration. As a countermeasure, in the above-mentioned embodiment, it is possible to easily detect the amount of shift in the input location in the X axis direction, or in other words, the amount of shift in the left-right direction of the user, by simply obtaining the difference between the input location of the partial image 213a and the display location of the partial image 213a.

In addition, in the above-mentioned embodiment, it is possible to correct the input location acquired after calibration to coordinates that reflect which hand is gripping the touch pen 12 and the amount of shift in the input location within the coordinate range based on the reference coordinates of the touch panel 10 obtained during calibration. As a result, the desired input location of the user is output to the application that is being executed, and the appropriate processing that the user desires to perform can be carried out.

### Modification Examples

An embodiment of the present invention has been described above, but the above embodiment is a mere example of an implementation of the present invention. Thus, the present invention is not limited to the embodiment described above, and can be implemented by appropriately modifying the embodiment described above without departing from the spirit of the present invention. Next, modification examples of the present invention will be explained.

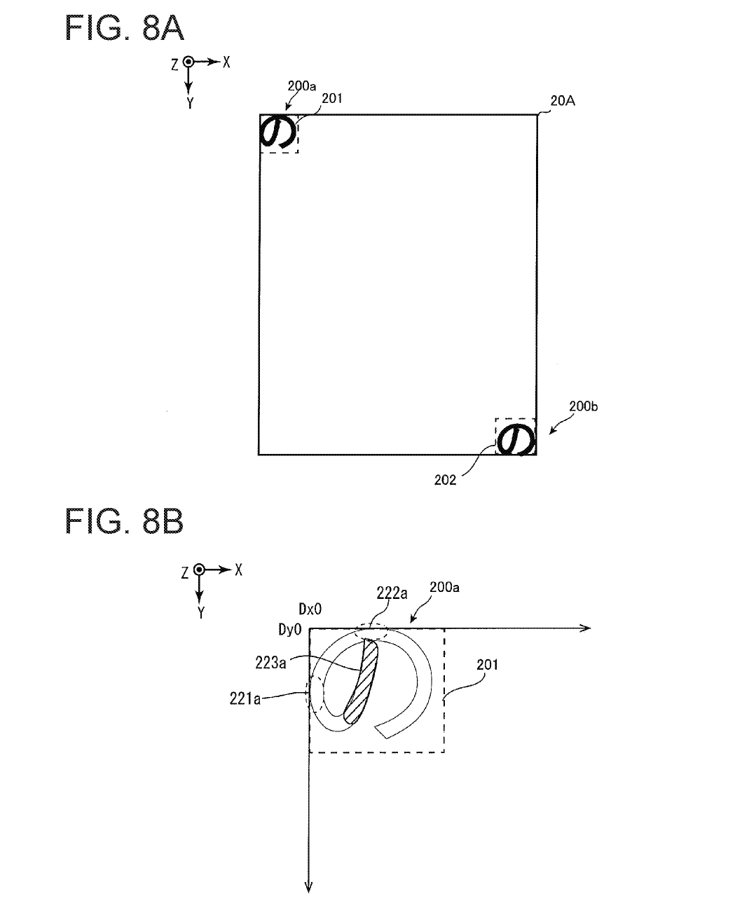

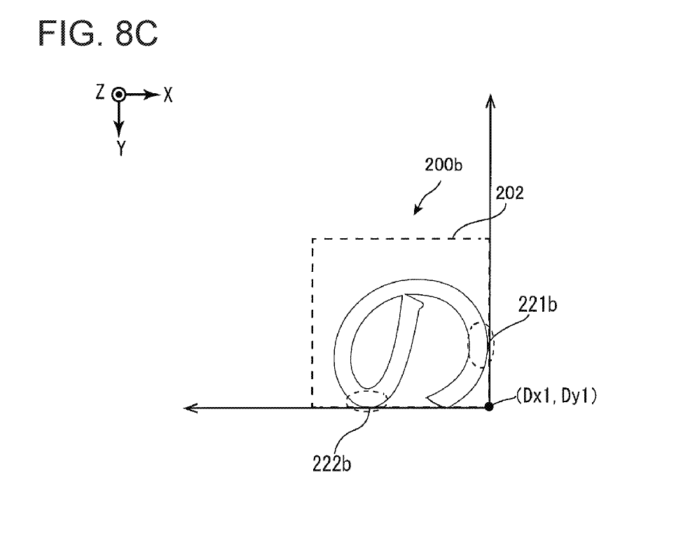

(1) In the above-described embodiment, an example was used in which letters of the alphabet that were different from one another were displayed as the character images 200a, 200b. Japanese characters may be displayed as well, however. As shown in FIG. 8A, the Japanese hiragana character “ [symbol] ” may be displayed as the character images 200a, 200b, for example. As shown in FIG. 8B, in such a case, the character image 200a shown in FIG. 8B is displayed in the display area 201 within the coordinate plane of the display area 20A such that portions 221a, 222a of the Japanese hiragana character “ [symbol] ” respectively contact the Y axis and the X axis. In addition, the character image 200b shown in FIG. 8C is displayed in the display area 202 within the coordinate plane of the display area 20A such that portions 221b, 222b of the Japanese hiragana character “ [symbol] ” respectively contact X=Dx1 and Y=Dy1.

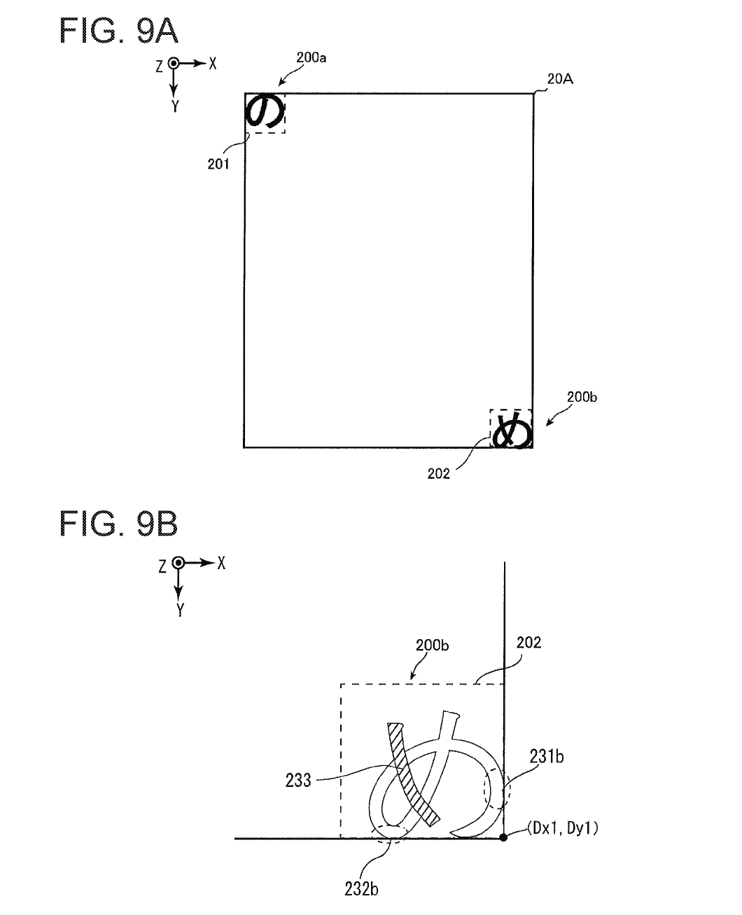

In addition, as shown in FIG. 9A, the Japanese hiragana character “ [symbol] ” may be displayed as the character image 200a in a similar manner as in FIG. 8A, while the Japanese hiragana character “ [symbol] ”, which differs from the character image 200a, may be displayed as the character image 200b. As shown in FIG. 9B, in such a case, the character image 200b is displayed such that portions 231b, 232b of the Japanese hiragana character “ [symbol] ” respectively contact X=Dx1 and Y=Dy1.

In the examples shown in FIGS. 8A and 9A, from among the input locations for the character image 200a, the minimum X coordinate may be identified as the coordinate corresponding to the Y axis (X=Dx0) of the display area 20A and the minimum Y coordinate may be identified as the coordinate corresponding to the X axis (Y=Dy0) of the display area 20A. In addition, from among the input locations for the character image 200b, the maximum X coordinate may be identified as the coordinate corresponding to X=Dx1 in the display area 20A, and the maximum Y coordinate may be identified as the coordinate corresponding to Y=Dy1 in the display area 20A.

In addition, in FIGS. 8A and 9A, when determining which hand is gripping the touch pen 12 in accordance with the input locations of the character image 200a, as in the above-mentioned embodiment, the device may determine whether or not the trajectory of the continuous input locations for the portion 221a of the character image 200a shown in FIG. 8B is located within the display area 201. In addition, when detecting the amount of shift in the input location in accordance with the input location of the character image 200a shown in FIG. 8A, as in the above-mentioned embodiment, the display device acquires the difference between the input location of the partial character image 223a that is a line segment substantially parallel to the Y axis and the display location of the partial image 223a. In this manner, the device acquires the amount of shift in the input location in the X axis direction.

When determining which hand is gripping the touch pen 12 in accordance with the input locations for the character image 200b shown in FIG. 9B, as in the above-mentioned embodiment, the device may determine whether or not the trajectory of the plurality of continuous input locations for the portion 231b of the character image 200b shown in FIG. 9B is located within the display area 202. In addition, when detecting the amount of shift in the input location in accordance with the input locations for the character image 200b shown in FIG. 9B, as in the above-mentioned embodiment, the device may obtain an average value for the difference between the input location of the partial image 233b that is a line segment substantially parallel to X=Dx1 (Y axis) and the display location of the partial image 233b.

Even in cases in which the character represented by the character images 200a, 200b is a Japanese character, the respective characters of the character images 200a, 200b have a line that is not parallel to the two sides of the display areas 201, 202 that border the exterior of the display area. In the present modification example, the portions (211a, 211b, 212a, 212b) of the character images 200a, 200b are curved line portions that curve toward, or in other words, portions of lines that are not parallel to, the two sides of the display area that border the exterior of the display areas in which the respective character images 200a, 200b are displayed.

It is preferable that the character represented by one of the character images 200a, 200b include a line segment from the border of the display area 20A that is substantially parallel to the upright direction of the character. When the partial image is a portion of a line that is not parallel to the upright direction of the character, the partial image contains a component in the upright direction of the character and a component in a direction that is orthogonal to the upright direction; thus, it is not possible to acquire the amount of shift in the input location in the left-right direction of the character just by acquiring the difference between the display location and input location of the partial image. In the present modification example, the respective characters represented by the character images 200a, 200b contain linear segments that are substantially parallel to the upright direction of the character; thus, it possible to easily acquire the amount of shift in the input location in a direction orthogonal to the upright direction of the character, or in other words, in the left-right direction of the user, by acquiring the difference between the input location and the display location of the partial images of the line segments.

(2) In the above-mentioned embodiment and Modification Example (1), examples were used in which the respective characters in the character images 200a, 200b were displayed in the display areas 201, 202 such that respective portions of the characters contacted the two sides bordering the exterior of the display area. The invention may be configured as follows, however. The characters may be displayed so as to protrude to the exterior of the display area by displaying the characters such that portions of the characters corresponding to the character images 200a, 200b overlap the border between the display areas 201, 202 and the exterior of the display area. In other words, the character images 200a, 200b may be images that represent a portion of the respective characters.

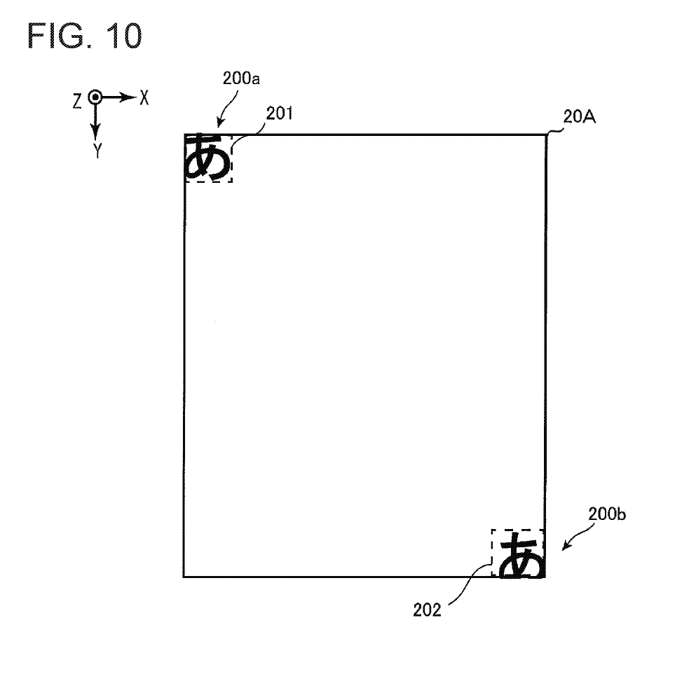

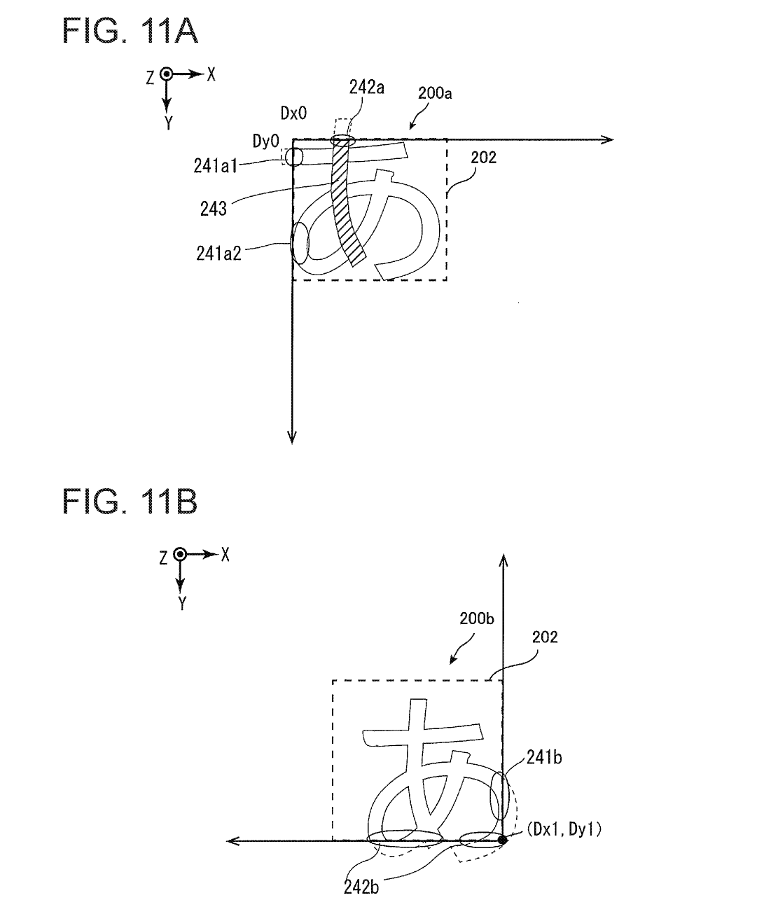

FIG. 10 is a schematic diagram showing the character images 200a, 200b of the present modification example being displayed in the display area 20A. In the present modification example, an example will be used in which the Japanese hiragana character “ [symbol] ” will be displayed as the character images 200a, 200b. FIG. 11A is a schematic diagram in which the character image 200a, which is located in the display area 20A and shown in FIG. 10, has been enlarged in the coordinate plane of the display area 20A. FIG. 11B is a schematic diagram in which the character image 200b, which is located in the display area 20A and shown in FIG. 10, has been enlarged in the coordinate plane of the display area 20A.

As shown in FIG. 11A, when a portion of the character represented by the character image 200a is disposed in the display area 201 so as to overlap the X axis and the Y axis, the character is displayed such that a portion of the character indicated by the dashed line protrudes to the exterior of the display area. In the character image 200a, a portion 242a of a line that intersects the X axis contacts the X axis, and a portion 241a1 of a line that intersects the Y axis contacts the Y axis. In addition, as shown in FIG. 11A, the character image 200a is displayed such that a curved line portion 241a2 that curves toward the Y axis contacts the Y axis.

In addition, as shown in FIG. 11B, when a portion of the character represented by the character image 200b is disposed in the display area 202 so as to overlap Y=Dy1 and X=Dx1, the character is displayed such that a portion of the character indicated by the dashed line protrudes to the exterior of the display area. In the character image 200b, a portion 242b of a line that intersects the side Y=Dy1 contacts the side Y=Dy1, and a portion 241b of a line that intersects the side X=Dx1 contacts X=Dx1.

In the present modification example, the minimum reference coordinates (Tx0′, Ty0′) of the sensing area are set in accordance with the input location of the character image 200a, and the maximum reference coordinates (Tx1′, Ty1′) of the sensing area are set in accordance with the input location of the character image 200b.

In the example shown in FIG. 11A, the character image 200a is displayed such that the character corresponding to the character image 200a visibly protrudes to the exterior of the display area. If the character image 200a is appropriately traced using the touch pen 12, locations that correspond to points on the X axis and the Y axis of the display area 20A in the coordinate plane of the sensing area will be input. Therefore, as in the above-mentioned embodiment, the control unit 40 will identify a minimum X coordinate and a minimum Y coordinate from the coordinates of the input locations for the character image 200a, will set the identified X coordinate and Y coordinate as the reference coordinates (Tx0′, Ty0′) of the sensing area on the X axis and the Y axis of the display area 20A, and reset the default values (Tx0, Ty0) of the sensing area.

In the example shown in FIG. 11B, the character image 200b is displayed such that the character corresponding to the character image 200b visibly protrudes to the exterior of the display area. Thus, If the character image 200b is appropriately traced using the touch pen 12, locations that correspond to the side Y=Dy1 and the side X=Dx1 of the coordinate plane of the sensing area will be input. Therefore, as in the above-mentioned embodiment, the control unit 40 will identify a maximum X coordinate and a maximum Y coordinate from the coordinates of the input locations for the character image 200b, will set the identified X coordinate and Y coordinate as the reference coordinates (Tx1′, Ty1′) of the sensing area corresponding to the side Y=Dy1 and the side X=Dx1 in the display area 20A, and reset the default values (Tx1, Ty1) of the sensing area.

In addition, in the present modification example, the display device will detect the amount of shift in the input location and the determination results regarding which hand is gripping the touch pen 12 in accordance with the input location of the character image 200a. Specifically, in the example shown in FIG. 11A, the control unit 40 determines that the hand gripping the touch pen 12 is the right hand when the trajectory of the plurality of consecutive input locations for the partial image 241a2 of the character image 200a is located within the display area 201. In addition, the control unit 40 determines that the hand gripping the touch pen 12 is the left hand when the trajectory of the plurality of consecutive input locations for the partial image 211a2 is not located within the display area 201.

In the example shown in FIG. 11A, the control unit 40 then, in a manner similar to the above-mentioned embodiment, detects the amount of shift in the input location by acquiring an average value for the difference between the coordinates of the plurality of input locations for the partial image 243 of the character image 200a and a plurality of coordinates of the partial image 243. As shown in FIG. 11A, the partial image 243 is a line segment that is substantially parallel to the Y axis. Thus, the control unit 40 acquires the amount of shift in the input location in the left-right direction (the X axis direction) of the user by acquiring the average value for the difference between the X coordinates in the sensing area that correspond to the display location of the partial image 243 and the X coordinates of the input location for the partial image 243.

In the present modification example, the Japanese hiragana characters corresponding to the character images 200a, 200b are displayed such that the characters visibly protrude to the exterior of the display area. The more familiar a user is with the Japanese hiragana characters corresponding to the character images 200a, 200b, the more accurately the character images 200a, 200b will be traced. As a result, a location near the border with the exterior of the display area is input, and it is possible to appropriately set reference coordinates representing the coordinate range of the display panel 10 corresponding to the display area 20A.

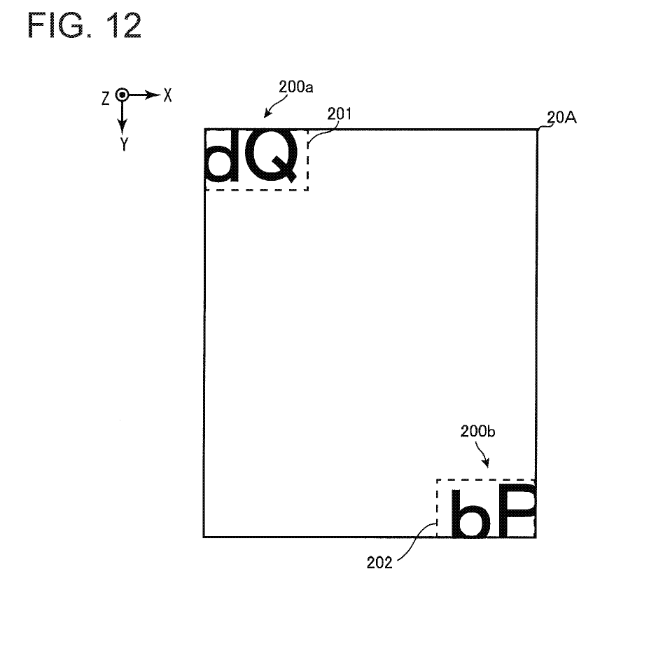

(3) In the above-mentioned embodiment, an example was used in which one letter of the alphabet was used for each of the character images 200a, 200b. Two or more letters of the alphabet may be used, however. An example will be explained hereafter in which two letters of the alphabet are used as the character images 200a, 200b, for example. FIG. 12 is a schematic diagram showing the character images 200a, 200b of the present modification example being displayed in the display area 20A. As shown in the example in FIG. 12, in the present modification example, a lowercase letter “d” and a capital letter “Q” from the alphabet are displayed in the display area 201 as characters corresponding to the character image 200a. In addition, a lowercase letter “b” and a capital letter “P” from the alphabet are displayed in the display area 202 as the characters corresponding to the character image 200b.

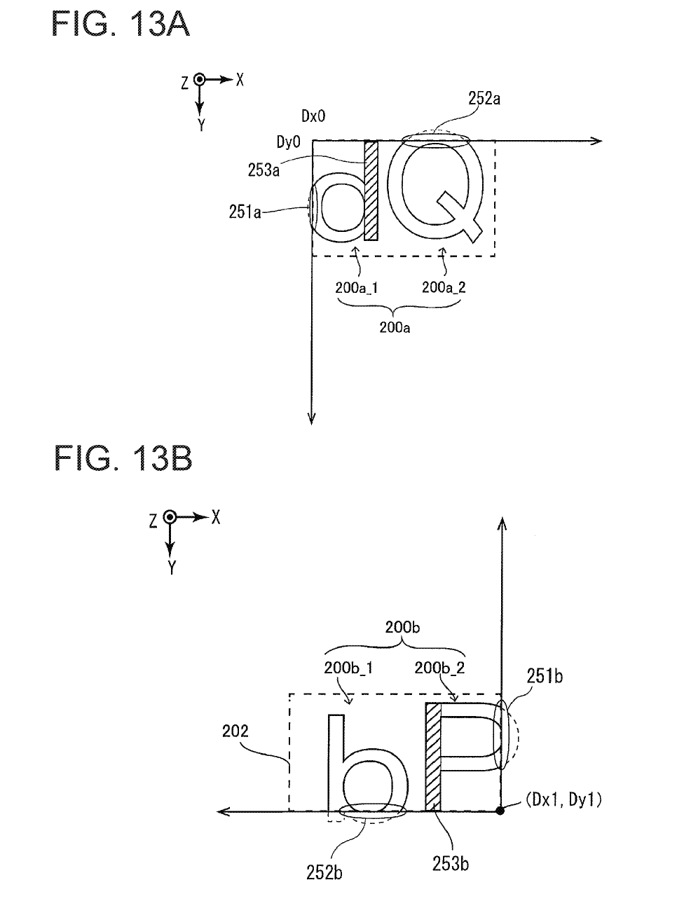

FIG. 13A is a schematic diagram which enlarges the character image 200a that is shown in FIG. 12 and that is located in the coordinate plane of the display area 20A. FIG. 13B is a schematic diagram which enlarges the character image 200b that is shown in FIG. 12 and that is located in the coordinate plane of the display area 20A.

As shown in FIG. 13A, the image 200a_1, which represents the letter “d” that forms part of the character image 200a, includes a curved line that curves toward the Y axis. The image 200a_1 is displayed with a portion 251a of the curved line contacting the Y axis, such that the character protrudes to the exterior of the display area. In other words, the image 200a_1 is a portion of the corresponding letter “d.” In addition, the image 200a2, which represents the letter “Q” that forms part of the character image 200a, includes a curved line that curves toward the X axis. The image 200a_2 is displayed with a portion 252a of the curved line contacting the X axis, such that the character protrudes to the exterior of the display area. In other words, the image 200a_2 is a portion of the corresponding letter “Q.”

In addition, as shown in FIG. 13B, the image 200b_2, which represents the letter “P” that forms part of the character image 200b, includes a curved line that curves toward the side X=Dx1. The image 200b_2 is displayed with a portion 251b of the curved line contacting the side X=Dx1, such that the character protrudes to the exterior of the display area. In other words, the image 200b_1 is a portion of the corresponding letter “P.” In addition, the image 200b_2, which represents the letter “b” that forms part of the character image 200b, includes a curved line that curves toward the side Y=Dy1. The image 200b_2 is displayed with a portion 252b of the curved line contacting the side Y=Dy1, such that the character protrudes to the exterior of the display area. In other words, the image 200b_1 is a portion of the corresponding letter “b.”

The portions 251a, 252a of the character image 200a respectively contact the Y axis and the X axis of the display area 20A. When the character image 200a is appropriately traced, locations near the Y axis and the X axis of the display area 20A are input. As a result, it is possible to identify reference coordinates (Tx0′, Ty0′) in the sensing area that correspond to the minimum coordinates (Dx0, Dy0) of the display area 20A. In addition, when the user recognizes the letters “d” and “Q” and inputs the entire letters (including the portions that are not displayed), a location on the X axis or the Y axis of the display area 20A will be input, and it is thus possible to more accurately set the reference coordinates (Tx0′, Ty0′).

Similarly, the portions 251b, 252b of the character image 200b respectively contact the side X=Dx1 and the side Y=Dy1 of the display area 20A. When the character image 200b is appropriately traced, locations near the side X=Dx1 and the side Y=Dy1 of the display area 20A are input. As a result, it is possible to identify reference coordinates (Tx1′, Ty1′) in the sensing area that correspond to the maximum coordinates (Dx1, Dy1) of the display area 20A. In addition, when the user recognizes the letters “b” and “P” and inputs the entire letters (including the portions that are not displayed), a location on the side X=Dx1 or the side Y=Dy1 of the display area 20A will be input, and it is thus possible to more accurately set the reference coordinates (Tx1′, Ty1′).

In the present modification example, the character image 200a and the character image 200b are displayed such that a portion of the curved line in the letter “d” represented by the image 200a_1 and a portion of the curved line in the letter “P” represented by the image 200b_2 respectively protrude to the exterior of the display area. Thus, in the present modification example, the determination regarding which hand is gripping the touch pen 12 and the detection of the amount of shift in the input location are performed in the following manner.

When the determination regarding which hand is gripping the touch pen 12 and the detection of the amount of shift in the input location are performed using the character image 200a, the device may determine which hand is gripping the touch pen 12 and detect the amount of shift in the input location in accordance with the input location of the partial image 253a in the image 200a_1 shown in FIG. 13A and the display location of the partial image 253a, for example. The partial image 253a is a line segment that is substantially parallel to the Y axis and the side X=Dx1.

Furthermore, when the determination regarding which hand is gripping the touch pen 12 and the detection of the amount of shift in the input location are performed using the character image 200b, the device may determine which hand is gripping the touch pen 12 and detect the amount of shift in the input location in accordance with the input location of the partial image 253b in the image 200b_2 shown in FIG. 13B and the display location of the partial image 253b, for example. The partial image 253b is a line segment that is substantially parallel to the Y axis and the side X=Dx1.

In such a case, the control unit 40 calculates the difference, in the sensing area, between the plurality of X coordinates corresponding to the display location of the partial image 253a or the partial image 253b and the X coordinates of the plurality of input locations for the partial image 253a or the partial image 253b, and then acquires the average value (Tx_Avg) for these calculations. When the average value Tx_Avg satisfies ITx_Avgl≦(a prescribed threshold) and Tx_Avg>0, the control unit 40 determines that the direction of the shift in the input location is in the negative direction of the X axis (the left hand direction), and then determines that the hand gripping the touch pen 12 is the left hand. Furthermore, when ITx_Avgl≦(a prescribed threshold) and Tx_Avg<0, the control unit 40 determines that the direction of the shift in the input location is in the positive direction of the X axis (the right hand direction), and then determines that the hand gripping the touch pen 12 is the right hand. The control unit 40 detects ITx_Avgl as the amount of shift in the input location.

The partial images 253a, 253b are line segment images that are substantially parallel to the Y axis. Thus, by acquiring the difference between the input location of the partial image 253a or the partial image 253b and the display location of the partial image 253a or the partial image 253b, it is possible to detect the direction to which the input location has shifted as a result of parallax. As a result, it is possible to determine which hand is gripping the touch pen 12 via the direction toward which the input location has shifted.

In the present modification example, an example was used in which the images 200a_1, 200a_2, which formed the character image 200a, were arranged and displayed along the X axis direction (a direction orthogonal to the upright direction of the characters). The images may be arranged and displayed along the Y axis direction (the upright direction of the characters), however. When the images 200a_1, 200a_2 forming the character image 200a are arranged along the Y axis direction, the images should be displayed in the order of the image 200a_2, and then the image 200a_1. In addition, when the images 200b_1, 200b_2 forming the character image 200b are arranged along the Y axis direction, the images should be displayed in the order of the image 200b_2, and then the image 200b_1.

Essentially, when the upright direction of the characters forming the character image 200a and the Y axis of the display area 20A are substantially parallel to each other, the image of a character having a curved line that curves toward the X axis of the display area 20A should be disposed such that a portion of the curved line contacts the X axis, and the image of a character having a curved line that curves toward the Y axis of the display area 20A should be disposed such that a portion of the curved line contacts the Y axis. In addition, when the upright direction of the characters forming the character image 200b and the Y axis of the display area 20A are substantially parallel to each other, the image of a character having a curved line that curves toward the side Y=Dx1 should be disposed such that a portion of the curved line contacts the side Y=Dx1, and the image of a character having a curved line that curves toward the side X=Dy1 should be disposed such that a portion of the curved line contacts the side X=Dy1.

Also in the present modification example, an example was used in which characters forming the character images 200a, 200b were displayed such that the characters visibly protruded to the exterior of the display area. However, if the characters do not visibly protrude, the device may be configured so as to display information near the character images 200a, 200b that prompts the user to trace the characters forming the character images 200a, 200b. In other words, in FIG. 12, the device may display “please trace the letters dQ” next to or below the display area 201, and may display “please trace the letters bP” next to or below the display area 202, for example.

(4) In the above-mentioned embodiment, an example was used in which the device determined which hand was gripping the touch pen 12 in accordance with the input location by the touch pen 12 for the partial image 211a that was a curved line segment of the character image 200a. Similar to Modification Example (3), however, the device may be configured so as to perform the determination regarding which hand is gripping the touch pen 12 and the detection of the amount of shift in the input location in accordance with the input location of the partial image 213a, which is a line segment substantially parallel to the Y axis, and the display location of the partial image 213a.

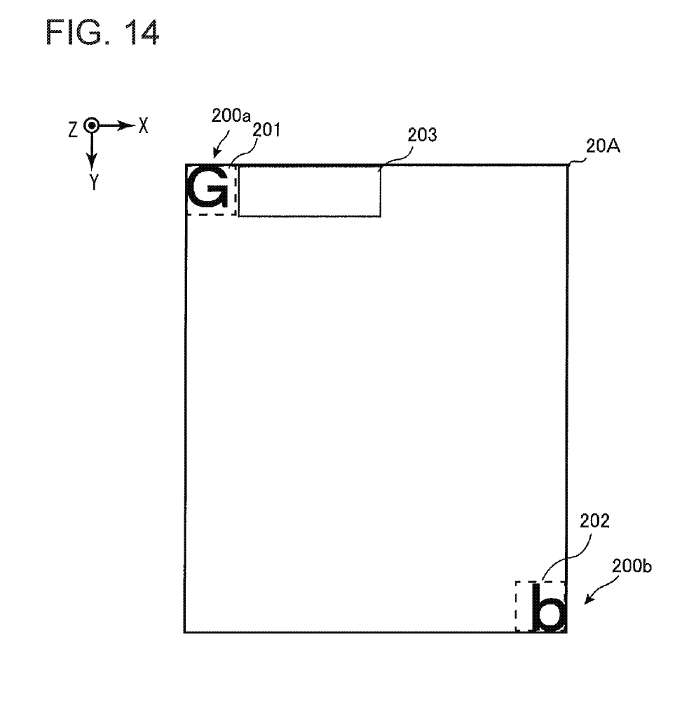

(5) In the above-mentioned embodiment, the display device 1 may be prevented from accepting input instructions on the touch panel 10 when the display device 1 is turned ON until the device receives an input operation of a prescribed password formed of a sequence of a plurality of characters. When the display device 1 is turned on, the control unit 40 displays the lock screen shown in FIG. 14, for example, in the display area 20A as a lock screen that limits input operations on the touch panel 10. On the lock screen, the first character of a prescribed password is displayed in the display areas 201, 202 as the character images 200a, 200b. In addition, once an input operation of tracing the character image 200a has been performed, an entry field 203 that prompts the input of the password from the second character on is displayed on the lock screen. The control unit 40 then, in a manner similar to the above-mentioned embodiment, determines the coordinate range of the touch panel 10, determines which hand is gripping the touch pen 12, and detects the amount of shift in the input location in accordance with the input location of the character images 200a, 200b by the touch pen 12. When the character sequence from the second character on that was input into the entry field 203 is the prescribed password character sequence, the control unit 40 executes the proper application program after the screen is unlocked, and removes any restrictions regarding input operations on the touch panel 10. After the lock screen has been unlocked, the control unit 40 corrects the input location input on the touch panel 10 in accordance with the determination results regarding which hand is gripping the touch pen 12, the amount of shift in the input location, and the coordinate range of the touch panel 10 stored in the storage unit 50.

(6) In the above-mentioned embodiment and modification examples, an example was used in which, when the display device 1 is turned ON, the display device 1 displays the character images 200a, 200b, and then determines which hand is gripping the touch pen 12 and detects the amount of shift in the input location. The device may be configured to perform these operations at the following times, however. The device may perform these operations when the device receives an operation from the user that instructs the device to perform calibration, and the device may also perform these operations after a non-operation period has elapsed in which no contact has been detected on the touch panel 10 for a fixed period of time, for example.

(7) In the above-mentioned embodiment, an example was used in which the display device determined which hand was gripping the touch pen 12 in accordance with the input location of the character image 200a. The determination regarding which hand is gripping the touch pen 12 may alternatively be determined using the following method. There are instances in which the character image 200a is traced using the touch pen 12 while a portion of the pinky-finger side of the palm of the hand gripping the touch pen 12 is supported by the touch panel 10. At such time, the contact area of the portion of the palm contacting the touch panel 10 is larger than the contact area of the touch pen 12; thus, the changes in capacitance will be different when the palm contacts the touch panel 10 as a result of the difference in size of the contact areas.

In the present modification example, the touch panel 10 is configured as a touch panel that can perform multi-touch detection, and can furthermore preset a threshold range for a signal value that corresponds to a change in capacitance resulting from contact by a portion of the palm. When a signal value output from the sense electrodes falls within the threshold range for signal values corresponding to contact by a portion of the palm, the touch panel control unit 12 outputs to the control unit 40 a signal indicating contact by a portion of the palm and the coordinates representing the contact location. When the control unit 40 acquires from the touch panel control unit 12 the coordinates of the contact by the portion of the palm, the control unit 40 determines which hand is gripping the touch pen 12 as a result of the relationship between the coordinates of the contact by the portion of the palm and the coordinates of the contact by the touch pen 12.

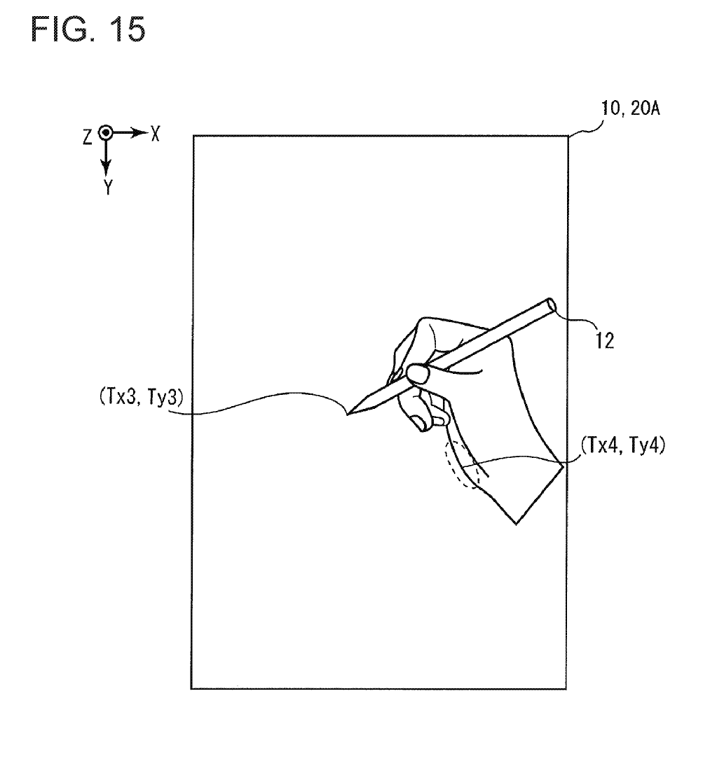

As shown in FIG. 15, when the portion of the palm of the hand gripping the touch pen 12 that is shown by the dashed line contacts the touch panel 10, the contacting portion has a substantially elliptical shape, for example. The control unit 40 determines which hand is gripping the touch pen 12 in accordance with the positional relationship between the coordinates (Tx4, Ty4) of a location that is in the substantial center of the portion contacting the touch panel 10 and the coordinates (Tx3, Ty3) of a location in which the touch pen 12 is contacting the touch panel 10. As shown in FIG. 15, when the X coordinate (Tx3) of the location in which the portion of the palm contacting the touch panel is in the positive direction of the X axis (the right side) with respect to the X coordinate (Tx3) of the location in which the touch pen 12 is contacting the touch panel, the control unit 40 determines that the hand gripping the touch pen 12 is the right hand. Furthermore, in the case opposite to what is shown in FIG. 15, when the X coordinate of the contact by the portion of palm is in the negative direction of the X axis with respect to the X coordinate of the contact by the touch pen 12, the control unit 40 determines that the hand gripping the touch pen 12 is the left hand. In this manner, by determining which hand is gripping the touch pen 12 in accordance with the positional relationship between the contact location of the portion of the palm gripping the touch pen 12 and the contact location of the touch pen 12, it is possible to improve the accuracy in determining which hand is gripping the touch pen 12 compared to cases in which the determination is made using only the input location of the character image 200a.

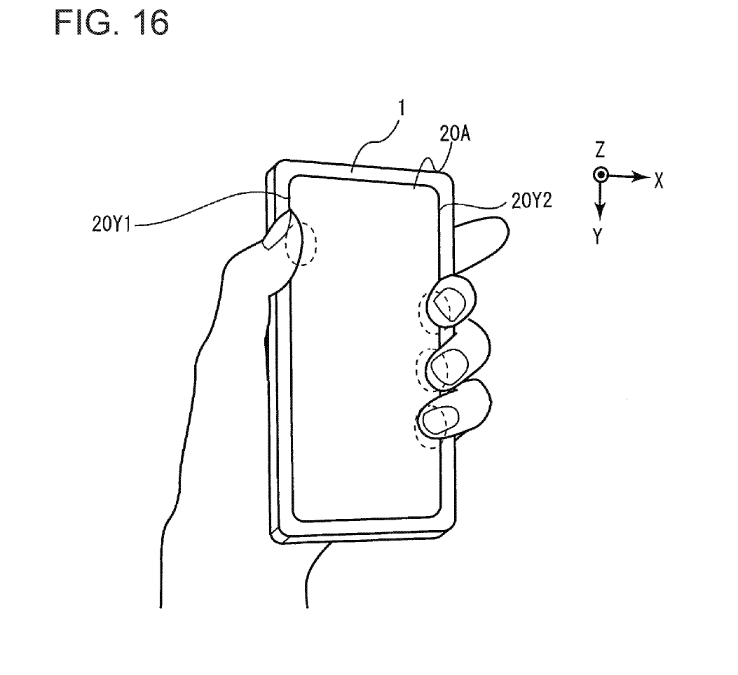

(8) In the above-mentioned embodiment, the control unit 40 may be further configured such that, when the control unit 40 detects an input location via contact by a hand, instead of contact by the touch pen 12, near the two opposing sides of the display area 20A, the control unit 40 determines which hand is gripping the touch pen 12 in accordance with these detection results. When the user holds the touch pen 12 with his right hand and performs input while the left hand holds the display device 1 as shown in FIG. 16, it is likely that the fingers of the left hand may contact the display panel 10 near two parallel sides 20Y1, 20Y2 that form the border between the display area 20A and the exterior of the display area, for example. When the display device 1 is supported by the left hand (when the touch pen 12 is being gripped by the right hand), the area contacted by the fingers of the left hand is larger near the side 20Y2 than the side 20Y1 in the display area 20A. Meanwhile, when the display device 1 is supported by the right hand (when the touch pen 12 is being gripped by the left hand), the area contacted by the fingers of the right hand is larger near the side 20Y1 than the side 20Y2 in the display area 20A (not shown). Thus, when an input location due to contact by a hand is detected near the two opposing sides of the display area 20A, the control unit 40 may further determine which hand is supporting the display device 1 in accordance with the area of the detected input location, and then determine which hand is gripping the touch pen 12 in accordance with these determination results. In this manner, by detecting contact by a hand near the border of the display area 20A and the exterior of the display area, it is possible to improve the accuracy in determining which hand is gripping the touch pen 12 compared to instances in which the hand gripping the touch pen 12 is determined only by the input location of the character image 200a.

(9) In the above-mentioned embodiment, the control unit 40 may be configured so as to display, in a location based on which hand is gripping the touch pen 12, a display location of an instruction image that directs the operation of a menu icon, an operation icon, or the like that has been set in an application installed in the display device 1. In such a case, when the hand gripping the touch pen 12 is the right hand, for example, the control unit 40 may display an instruction image that has a frequency of operation higher than a prescribed frequency of operation on the right side (positive direction of the X axis) of the display area 20A, and may display an instruction image with a frequency of operation below the prescribed frequency of operation on the left side (the negative direction of the X axis) of the display area 20A. In addition, when the hand gripping the touch pen 12 is the left hand, the control unit may display the instruction images in a manner opposite to that when the right hand was gripping the touch pen 12; namely, the control unit 40 may display an instruction image with a frequency of operation higher than a prescribed frequency of operation on the left side (negative direction of the X axis) of the display area 20A, and may display an instruction image with an a frequency of operation below the prescribed frequency of operation on the right side (the positive direction of the X axis) of the display area 20A. In short, the display device should display an instruction image in a location of the display area 20A that is closer to the hand gripping the touch pen 12. By displaying the instruction image with a higher frequency of operation in a location closer to the hand gripping the touch pen 12, it is possible to improve the user friendliness of the device.

(10) In the above-mentioned embodiment, an example was used in which display areas located in opposing corners of the display area 20A included a display area 201 that included minimum values (Dx0, Dy0) located in the upper left of the display area 20A shown in FIG. 4A, and a display area 202 that included maximum values (Dx1, Dy1) located in the lower right of the display area 20A. The display areas located in opposing corners of the display area 20A may be configured in a different manner, however. In FIG. 4A, the display device may be configured so as to display character images in a display area (hereafter abbreviated as “the upper right display area”) that includes (Dx1, Dy0) located in the upper right, and a display area (hereafter abbreviated as “the lower left display area”) that includes (Dx0, Dy1) located in the lower left, for example. When one letter of the alphabet is displayed as the character image, it is preferable that the letter in the character image displayed in the upper right display area have a curved line that curves toward the X axis and a curved line that curves toward the side X=Dx1. In addition, it is preferable that the letter included in the character image displayed in the lower left display area include a curved line that curves toward the Y axis and a curved line that curves toward the side Y=Dy1. Letters such as “R” and “p” may be used as the characters displayed in the upper right display area, for example, and letters such as “d” and “q” may be used as the characters displayed in the lower left display area, for example.

(11) In the above-mentioned embodiment and modification examples, an example was used in which the respective characters in the character images 200a, 200b were letters from the alphabet or Japanese hiragana characters. However, the characters in the character images 200a, 200b may instead be characters from the languages of a variety of countries, such as Japanese katakana letters, kanji, hangul characters, or the like, or may instead be numbers. In addition, the character images 200a, 200b may be made of two or more characters that are a combination of letters from the alphabet and numbers, or may be made of two or more characters that are combination of characters from the languages of a variety of countries.

(12) In the above-mentioned embodiment and modification examples, an example was used in which the display areas 201, 202 located in opposing corners of the display area 20A were determination areas and the character images 200a, 200b were respectively displayed in the respective determination areas. The display device may be configured, however, such that display areas located in one or more corners of the display area 20A are determination regions and the character images are displayed therein.

### INDUSTRIAL APPLICABILITY

The present invention can be applied to the industry of display devices equipped with touch panels.

1. A display device, comprising:
a display unit having a rectangular display area;
a touch panel on the display unit; and
a processor configured to perform the following:
causing a character image to be displayed in a determination area located in a corner of the display area such that the character image contacts two sides of the determination area that border an exterior of the display area;
causing instructions to trace, by a touch pen, the character image displayed in the determination area to be communicated to a user;
determining whether a hand of the user gripping the touch pen is a left hand or a right hand in accordance with input locations of the touch pen on the character image performed by the user in response to said instructions and a display location of the character image;
detecting a shift amount with respect to the respective input locations in accordance with the input locations of the touch pen on the character image performed by the user and the display location of the character image; and
correcting an input location of the touch pen in the display area that will be performed by the user thereafter in accordance with the detected shift amount.

2. The display device according to claim 1,
wherein the determination area is provided in a plurality, the plurality of the determination areas are respectively located in two opposing corners of the display area, and respective character images are displayed in the plurality of the determination areas,
wherein the processor is further configured to set a coordinate range of the touch panel that corresponds to the display area in accordance with the input locations of the touch pen on the character images displayed in the respective determination areas, and
wherein the processor corrects the input location of the touch pen that will be performed by the user thereafter in accordance with the set coordinate range.

3. The display device according to claim 1,
wherein an upright direction of a character shown in the character image is substantially parallel to an extension direction of one of the two sides of the determination area,
wherein the character image has a line segment that is substantially parallel to said one side, and
wherein the detection unit detects said shift amount in the input locations in accordance with input locations of the touch pen on the line segment and a display location of the line segment.

4. The display device according to claim 1,
wherein the character image includes a curved line that curves toward one of the two sides of the determination area, the one side being substantially parallel to an upright direction of a character shown in the character image,
wherein in the character image, a section of the curved line contacts the one side of the determination area, and
wherein the processor determines whether the hand gripping the touch pen is the left hand or the right hand by determining whether or not a trajectory of input locations of the touch pen on the section of the curved line is located within the determination area.

5. The display device according to claim 1,
wherein the character image includes a curved line that curves toward the two respective sides of the determination area, and
wherein, in the character image, portions of the curved line respectively contact the two sides of the determination area.

6. The display device according to claim 1, wherein, in determining whether the hand of the user gripping the touch pen is the left hand or the right hand, if an input operation other than by the touch pen is performed on the touch panel and if said input operation is an input operation by a hand, the processor determines which hand is gripping the touch pen in accordance with a positional relationship between an input location of said input operation by the hand and the input locations of the touch pen.

7. The display device according to claim 1, wherein, in determining whether the hand of the user gripping the touch pen is the left hand or the right hand, if an input operation other than by the touch pen is performed on the touch panel near at least two opposing sides of four sides forming the display area, the processor determines which hand is gripping the touch pen in accordance with a contact area of the input operation.

8. The display device according to claim 1,
wherein the processor sets a lock function to lock the display unit when the display device is initially turned ON and/or when a non-input state in which no input operation is performed on the touch panel lasts for a prescribed period of time, said lock function not allowing any input operation other than a character sequence that matches a character sequence of a prescribed password to be accepted until said character sequence is input, the processor deactivating the lock function when the character sequence that matches said character sequence is input,
wherein the character image is a portion of the character sequence of the prescribed password, and
wherein, when an input operation is performed by the touch pen after the lock function has been deactivated, the processor corrects an input location of the input operation in accordance with the detected shift amount.

9. The display device according to claim 1, wherein the processor causes an instruction image for directing operation of an application installed on the display device to be displayed in a location in the display area that is determined based on whether the user is right-handed or left-handed.
